(19) United States
(12) Patent Application Publication
(10) Pub. No.: US 2003/0055753 A1
(43) Pub. Date: Mar. 20, 2003

(54) Spare parts and consumables management system

(75) Inventors: Carl Dellar, Saratoga, CA (US); Trevor Morris, Oakland, CA (US); Norbert Hendrikse, Berkeley, CA (US); Kris J. Wainscott, Sausalito, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Eshinui Incorporated, Hayward, CA

(21) Appl. No.: 09/956,586

(22) Filed: Sep. 17, 2001

(51) Int. Cl. G06F 17/60

(52) U.S. Cl. 705/29

(57) ABSTRACT

A modular, integrated software-based system for tracking spare parts, consumables and refurbishable parts. These are tracked for usage in tools, in kits, and to provide links to additional data, such as on-line manuals. Individual parts are assigned unique tracking numbers and are tracked. Tracking data is available in different formats for different personnel. Kits are tracked, a tracking number is assigned to reusable parts in the kit, and the maintenance of the reusable parts is logged and tracked through the software. Part lists are provided for the parts in each store, with the part ID in each list being linked to a description in a central repository. Separate stores with the same parts are also linked to the same description. In one embodiment, the invention provides a needs list for auditing, a pick list for picking items from the store, and a stocking list for indicating the parts that have been stocked. Warranty information is electronically tracked for parts in the tool in comparison with actual use information. In addition, decontamination/cleaning/refurbishment of parts are tracked.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates in general to the logistics of equipment maintenance, and in particular to the tracking of spare parts, consumables and refurbishables.

A problem encountered by many industries is providing the correct inventory for spare parts for tools or instruments used in a business. In addition, keeping track of maintenance requirements, warranty data and parts forecasting is problematic.

In the medical industry, one approach is set forth in U.S. Pat. No. 6,223,137. Hospital instruments are marked with a bar code, including surgical kits which have a part number for the kit. The software system stores a maintenance schedule, and tracks the use of instruments and the maintenance procedures performed on them. U.S. Pat. No. 5,425,375 shows a reusable medical device which includes a sensor for electronically generating an electrical signal each time the device is used. U.S. Pat. No. 5,374,813 shows a system for electronically linking an instrument sterilization and maintenance facility with a shipping carrier and a hospital facility. This system tracks the sterilization and maintenance of surgical instruments and instrument kits using bar code readers.

The above described patents show both bar code reader input and direct electrical sensor input for monitoring use of tools. Another example of direct input is shown in U.S. Pat. No. 6,125,312, which shows the monitoring of an aircraft engine for providing an input to a system for tracking, maintenance and warranty information. U.S. Pat. No. 5,864,784 shows a hand held device which can be used for entering maintenance and operating data for a tool. Another approach is shown in U.S. Pat. No. 6,170,742, which uses a smart card which is kept with the machine, and stores entered repair and maintenance information.

With the advent of the internet, many systems have been developed for transmitting information over the internet. For example, U.S. Pat. No. 6,152,369 discloses a system for generating a URL from a bar code for tracking purposes.

In addition to the above described patents, many software systems exist for inventory control. Inventory control, purchasing and supply chain software are provided by such providers as SAP, J. D. Edwards, Oracle, 12, and others. However, such inventory control does not typically monitor the use in the tools, but merely the storage of the parts.

In semiconductor fabs, or foundries for processing wafers, managing spare parts and consumables for tools is complex and critical. A foundry can have hundreds of machines running dozens of processes with many spare parts and consumables being used for each machine/process. The absence of a needed spare part or consumable at a critical point can mean damage to expensive wafers in process, and those in a pipeline in other machines which are waiting to use the machine which is down. In addition, the time a machine is down reduces wafer output, which can be very expensive.

Because of this importance, a typical approach is to provide point of use spare part stores (POUSM) near each cluster of tools, in the clean room itself with the tools. Separately, a “BreadMan” store is provided nearby for resupplying the individual point of use stores. Finally, a central inventory store may be maintained by the foundry for resupplying the BreadMan stores. Personnel periodically inventory each of the stores using an audit list and generate a corresponding needs list to resupply the stores from the next store of the supply chain. When the audit is complete, a pick list is generated indicating which supplies are to be taken from the resupply store in order to replenish the depleted stores. When the depleted stores are stocked, a checklist is used to confirm the stocking which is done. As the main facility inventory store is depleted, purchasing personnel can order replacement parts from suppliers. While this system is designed to ensure that needed spare parts will be available, it does this by providing inventory levels which range from 3-5 times the yearly consumption. Without POUSM, maintenance engineers don't have timely information about parts and their availability, which can lead to tool downtime.

Another problem is the misidentification of parts, which can also cause tool downtime if an engineer isn't able to identify the proper part, and where it is located in the stores. Additional problems arise with respect to parts which are reusable after refurbishing and/or cleaning. The allowed number of times these parts are cleaned and/or refurbished needs to be tracked, as well as which machines and processes they are used in. Especially with the new copper processes coming on line, contamination is a concern between copper and other (aluminum) process types.

Simple control systems available for other industries cannot be directly applied to the fab industry due to the differences in complexity and the need for many different types of personnel to access the information for different reasons. One set of information is needed by a maintenance engineer, another set by an analyst, another by a purchasing agent, etc.

### BRIEF SUMMARY OF THE INVENTION

The present invention provides a modular, integrated software-based system for tracking spare parts, consumables and refurbishable parts. These are tracked for usage in tools, in kits, and to provide links to additional data, such as on-line manuals. Individual parts are assigned unique tracking numbers and are tracked. Tracking data is available in different formats for different personnel.

In one aspect of the invention, kits having a number of parts are tracked. Each kit is assigned a unique ID, and a part number is recorded for each of the parts in the kit. Not only are the kits tracked, a tracking number is assigned to reusable parts in the kit, and the maintenance of the reusable parts is logged and tracked through the software.

In another aspect of the invention, parts are tracked and managed at the point of use. A single description is provided for each part type in a central repository. Part lists are provided for the parts in each store, with the part ID in each list being linked to a description in the central repository. Separate stores with the same parts are also linked to the same description. In one embodiment, the invention provides a needs list for auditing, a pick list for picking items from the store, and a stocking list for indicating the parts that have been stocked.

In another aspect of the invention, warranty information is electronically tracked for parts in the tool in comparison with actual use information. In addition, decontamination/cleaning/refurbishment of parts are tracked using a tracking number for the part. In addition, a list of tools in which the part has been installed is provided to allow a determination of any contamination issues. In one embodiment, the list includes the dates of installation and removal, as well as the particular maintenance procedures performed upon the part along with the date of the maintenance.

In one embodiment, the present invention is implemented using a web-based application with customized browser interfaces for different users, such as an analyst desktop, a refurbisher desktop, and a small, PDA interface for use in a clean room environment by maintenance and stocking personnel. The PDAs preferably have a wireless connection to the network, and include a bar code scanner attachment for inputting bar code information from parts.

Other aspects of the present invention are described in more detailed in the remainder of this application. For example, the present invention also provides the ability to track multiple part numbers for the same part. An on-line manual is integrated with the present invention, with URL links allowing a user to easily move between the manual and inventory or other information about the part, and vice-versa. In addition, a number of techniques for optimally implementing the above described system are set forth.

For a further understanding of the nature and advantages of the invention, reference should be made to the following description taken in conjunction with the accompanying drawings.

### BRIEF DESCRIPTION OF THE DRAWINGS

FIG. 1 is a block diagram illustrating the different modules of an embodiment of the present invention on a functional level.

FIG. 2 is a block diagram illustrating different users and locations for connecting to the tracking system in an embodiment of the invention.

FIGS. 3-11 are illustrations of embodiments of pages relating to kits.

FIGS. 12-16 are illustrations of embodiments of pages relating to parts information and tracking.

FIGS. 17-23 are illustrations of embodiments of pages showing auditing interfaces.

FIGS. 24-30 are illustrations of embodiments of pages showing part availability searching and reports.

FIG. 31 illustrates a PDA with an interface according to an embodiment of the invention.

FIGS. 32 and 33 illustrate wireless network cards used with embodiments of the invention.

FIGS. 34-40 are illustrations of embodiments of pages showing a link to a online manual.

FIGS. 41-44 are illustrations of embodiments of pages illustrating a PDA version of pages for parts information and tracking.

### DETAILED DESCRIPTION OF THE INVENTION

Functional Overview

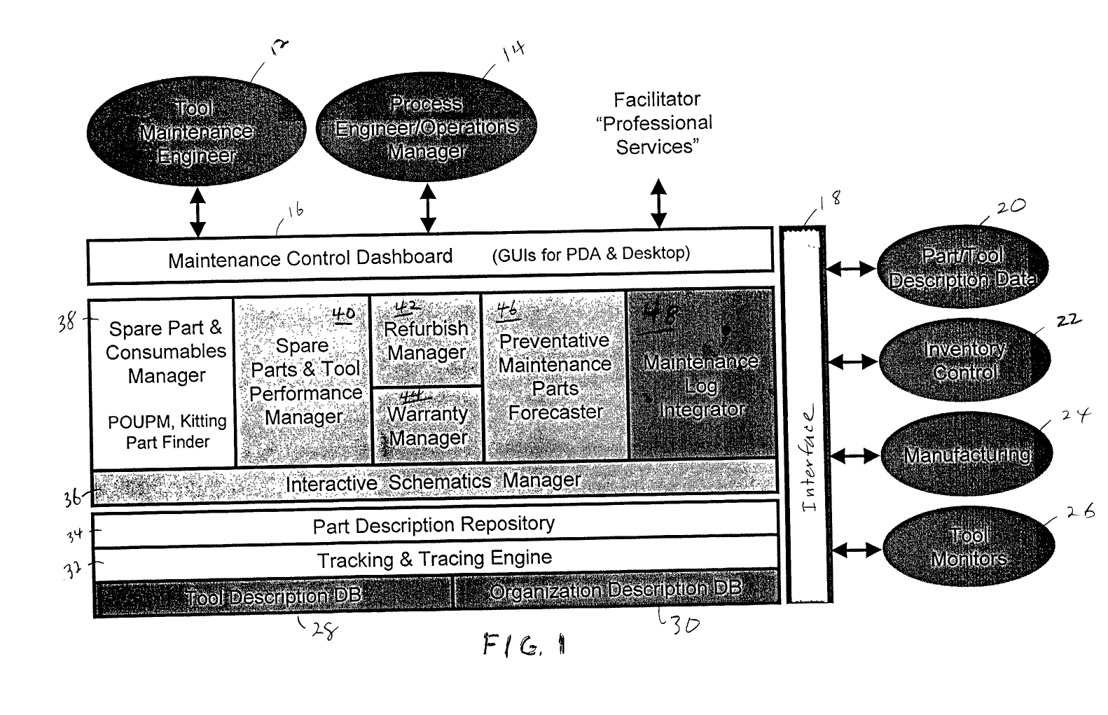

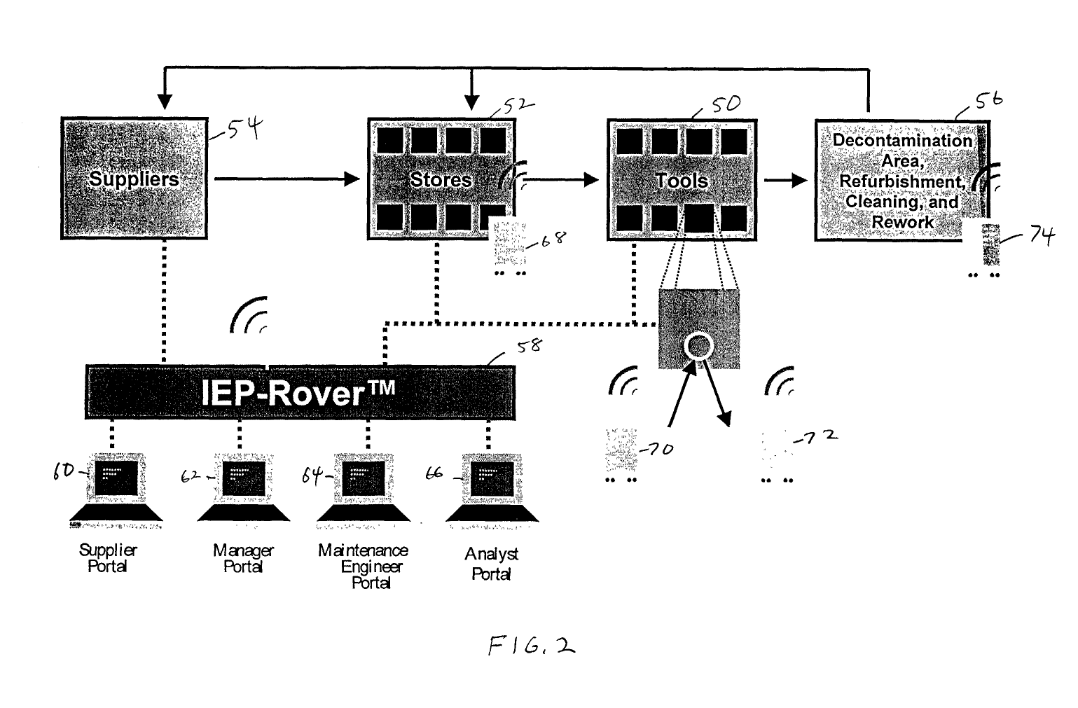

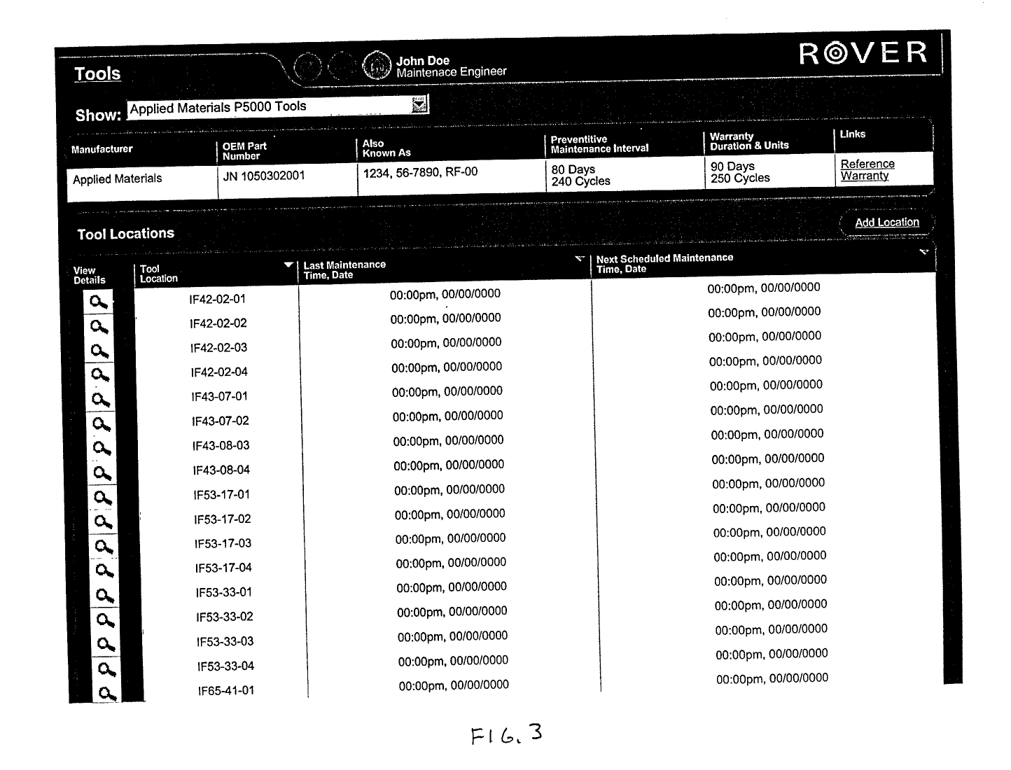

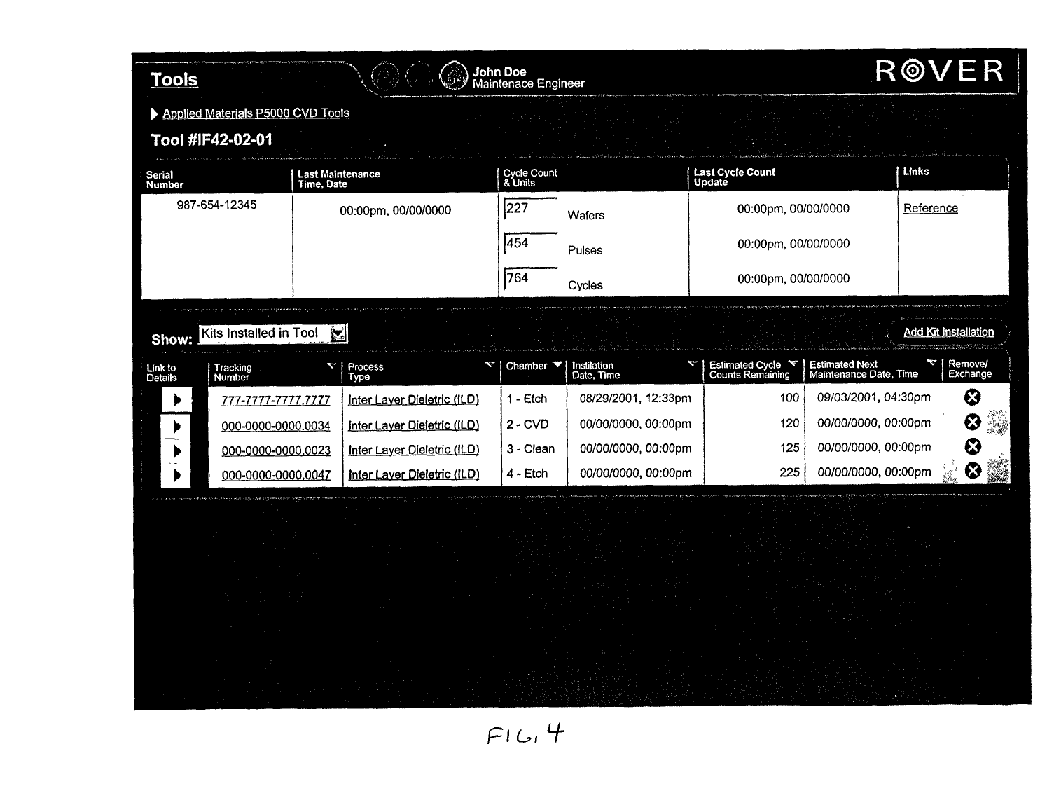

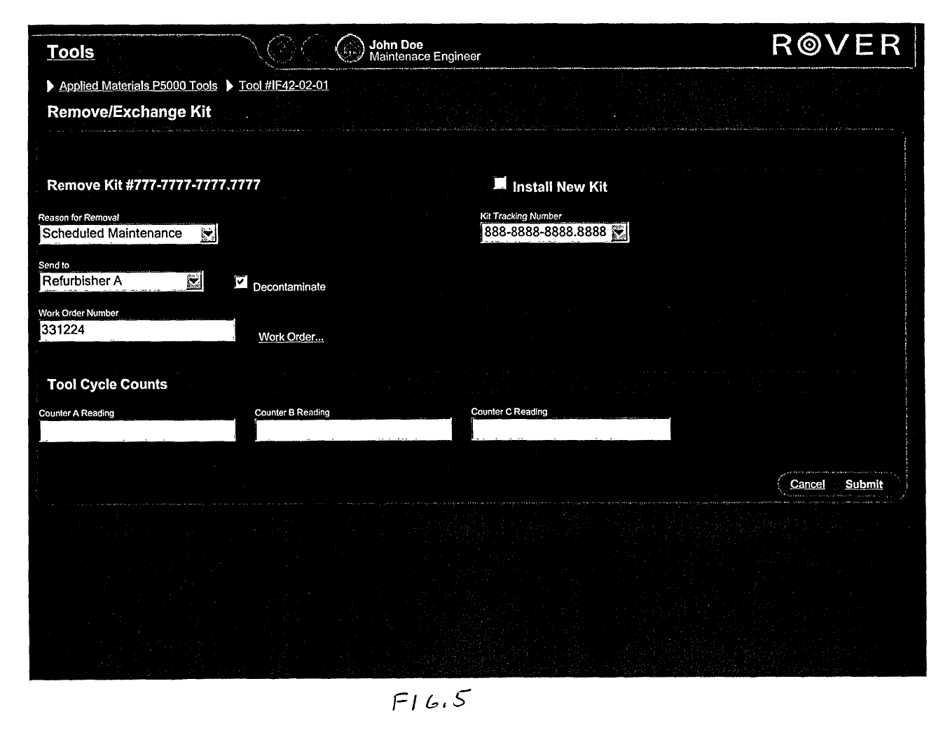

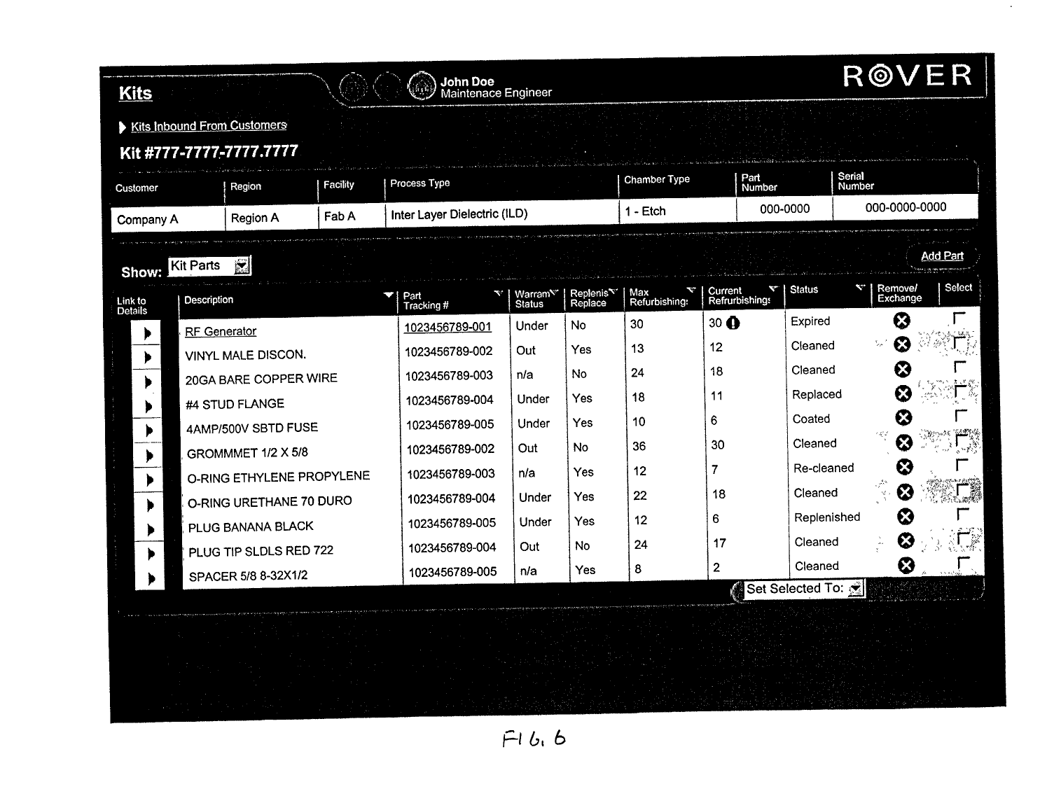

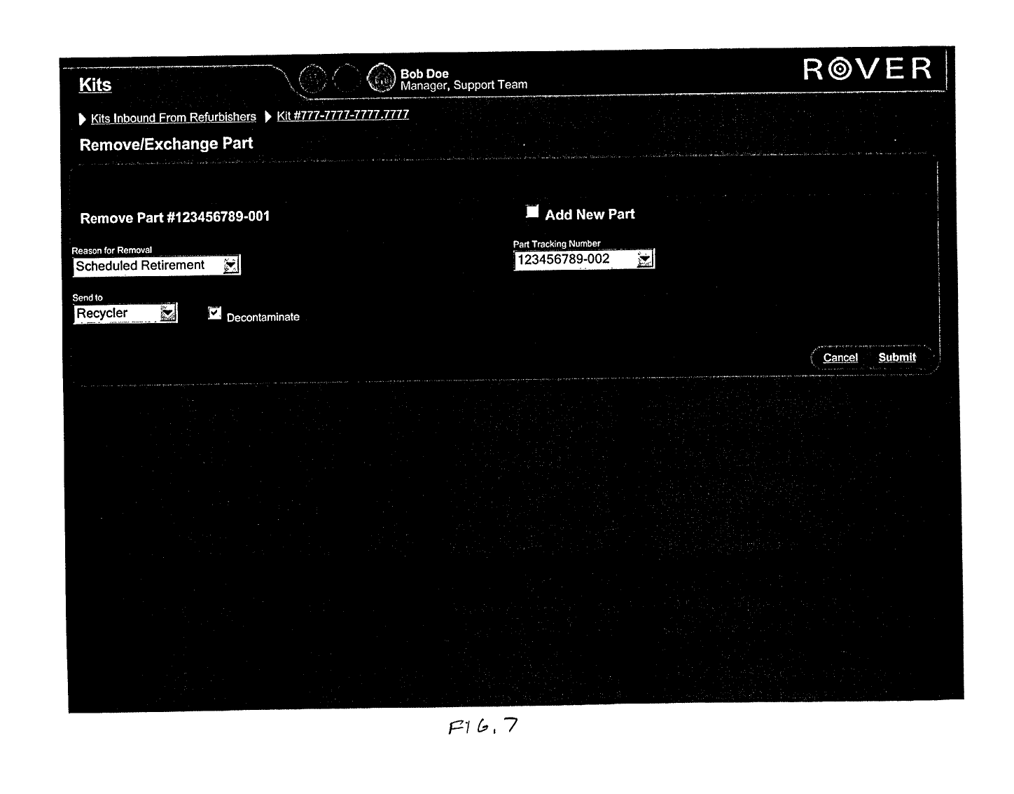

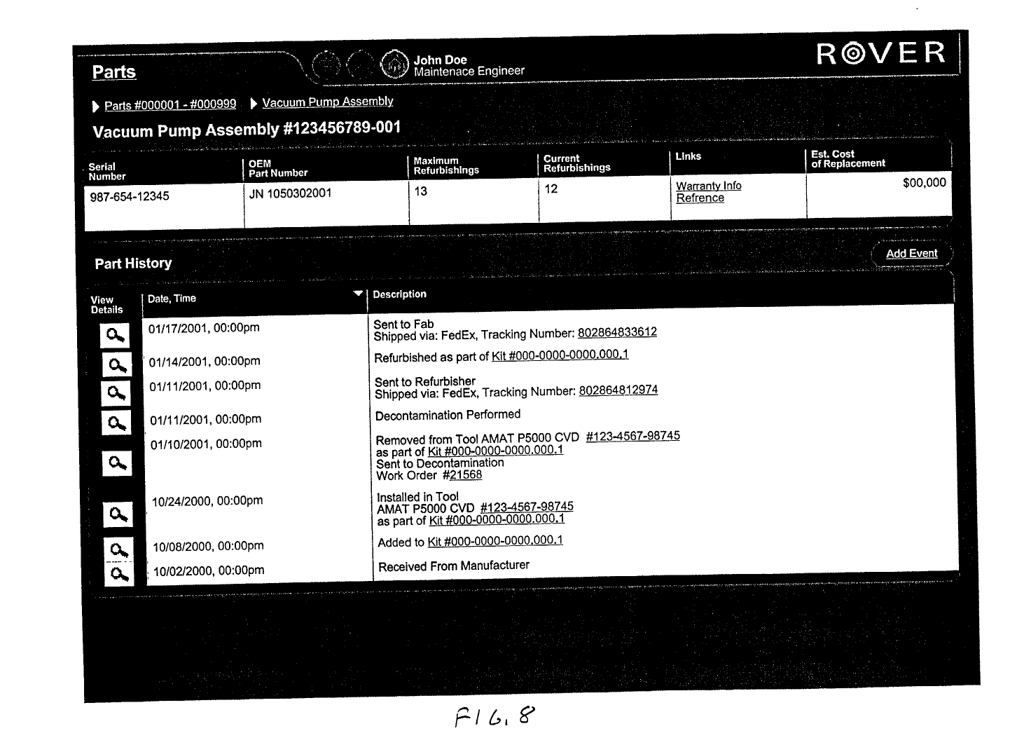

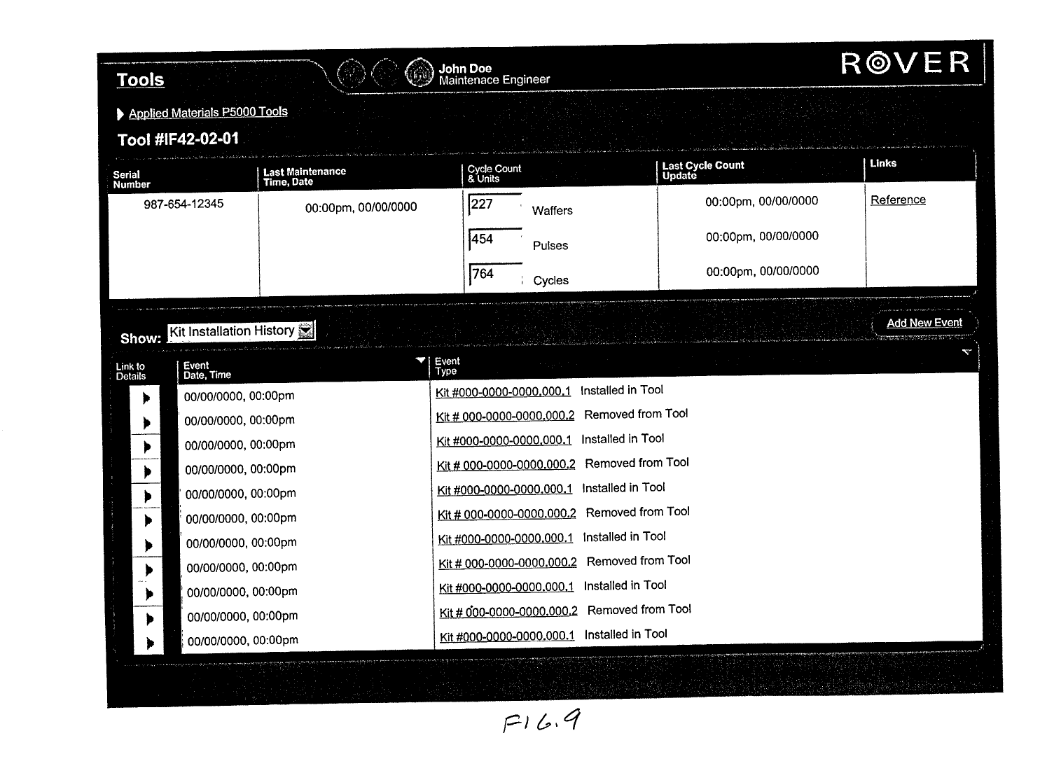

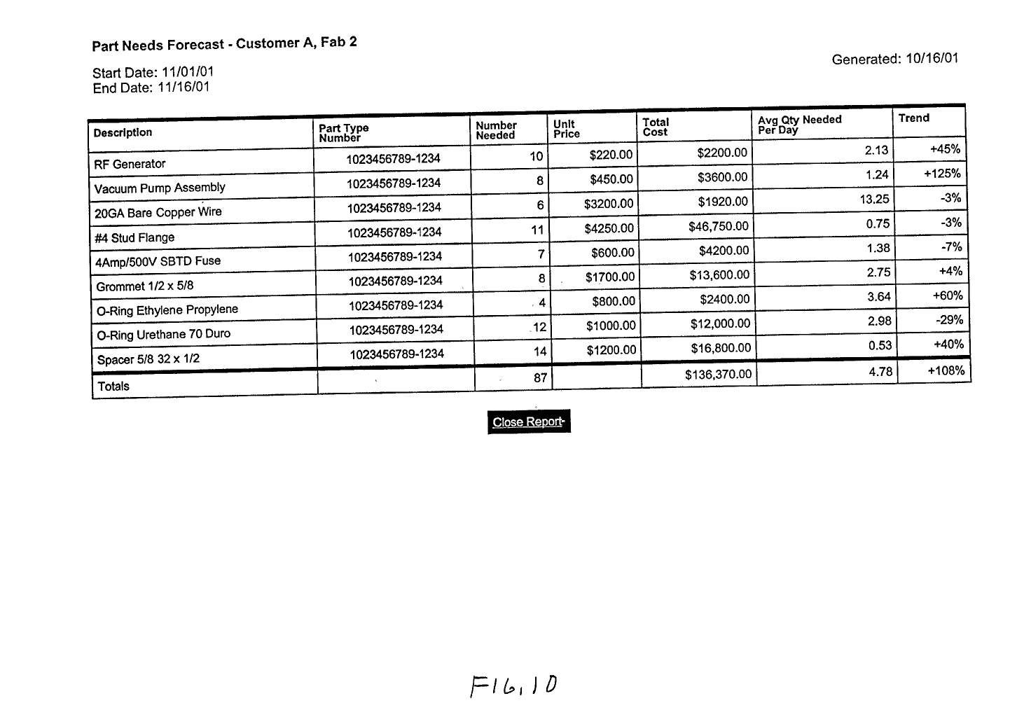

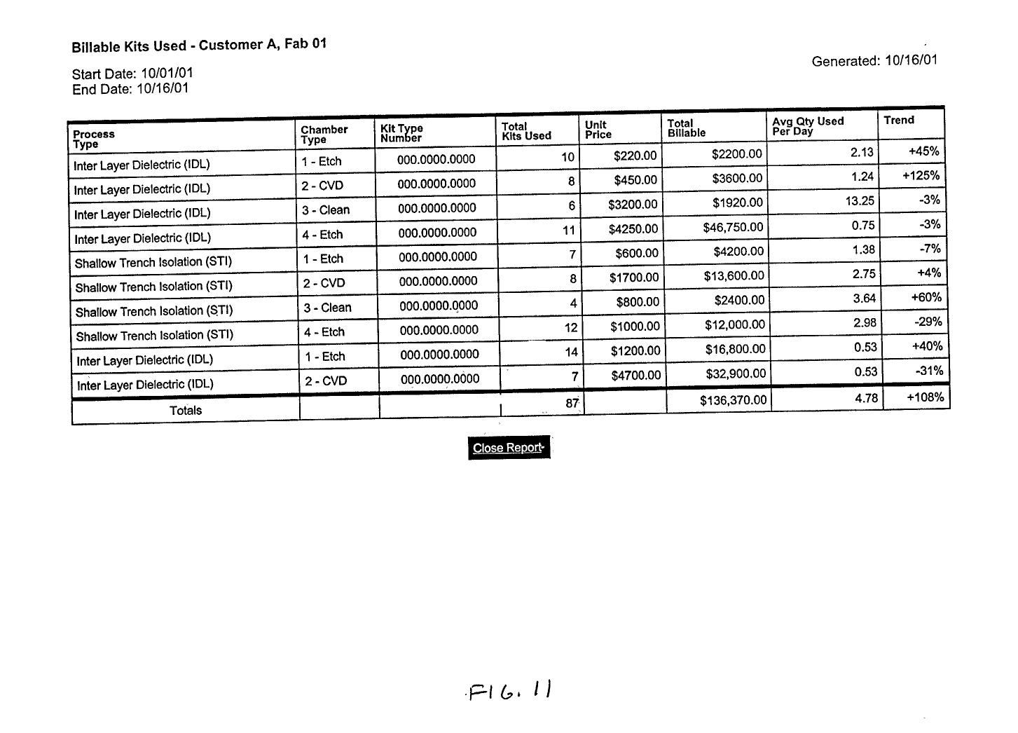

FIG. 1 is a system block diagram of an embodiment of the invention from a functional view point. The system is accessible by different personnel, such as a tool maintenance engineer 12 or a process engineer/operations manager 14. Different personnel access the system through maintenance control dashboards 16, which can be personalized depending upon the type of personnel accessing the system, and also can be provided on either a desktop or a PDA. The system also interfaces through an interface 18 containing different external interface adaptors. This can interface with existing database or software systems, such as parts/tool description database 20, inventory control system 22, manufacturing system 24, and tool monitors 26.

The databases of the system include a tool description database 28 and an organization description database 30. The tool description database describes the different tools for which spare parts and consumables are needed, while the organization description describes such things as the locations of the tools in different foundries and the locations of stores of spare parts.

A tracking and tracing engine 32 interacts with these databases, and with a part description repository 34. Also provided is an interactive schematics manager 36. A number of different modules interact with these different software engines and databases.

A spare parts and consumables manager module 38 includes a number of elements. A point of use parts management (POUPM) provides visibility for parts across all local and remote stores. It provides support to the PDA interface for audit and stocking cycles, and integrates with multiple supply sources. This module can be used by the other modules as appropriate, as will be discussed below. A kitting module provides performance, consumption and cost tracking of kits and their constituent parts. Administrative interfaces are provided for kit type and part lists. Interfaces are provided for stocking of kits and for review by maintenance engineers. A part finder module provides access and drill down for users to provide part descriptions, part availability, part locations, part number synonyms, and service and use history for parts. Module 38 also includes a part request communication system which tracks requests for spare parts. This provides a formal link between the maintenance engineers and the spare part stores. Links can be provided to email addresses or pagers for alerts based on the urgency of request. In addition, reports can be generated for analysts.

Interactive schematics manager 36 enables an engineer to drill down from the schematic level to part descriptions. From the part descriptions, the engineer can check on availability, part service history, use, locations, etc.

A spare parts and tool performance manager 40 traces consumables, spares and reworked items. This module allows tracking of batches of parts to determine what tools they ended up in. The performance of tools can be monitored, as well as the performance of parts in a tool.

A refurbish manager 42 and a warranty manager 44 allow for the tracking of warranted equipment and refurbished equipment. The location of the refurbished unit can be determined, and work orders and certificates of completion can be provided online. Warranty and refurbish period expirations can be used to generate alerts or alarms, and equipment performance can be monitored.

A preventative maintenance parts forecaster 46 provides parts and consumables forecasting based on expected wafer loads. This provides an increased ability to maintain an accurate part inventory level, as well as scheduling maintenance and repair. This ensures that the right parts are stocked, and the stocking of obsolete parts is minimized.

A maintenance log integrator 48 provides a log of a tool's service record. It allows tracing from a log to a part, and from a part to a batch. An engineer can be alerted as to warranties, or refurbish times, etc.

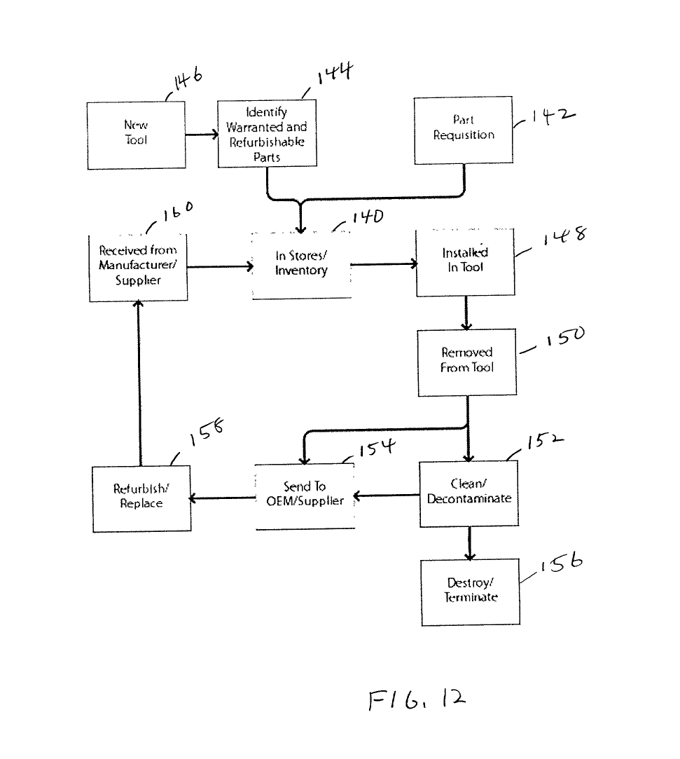

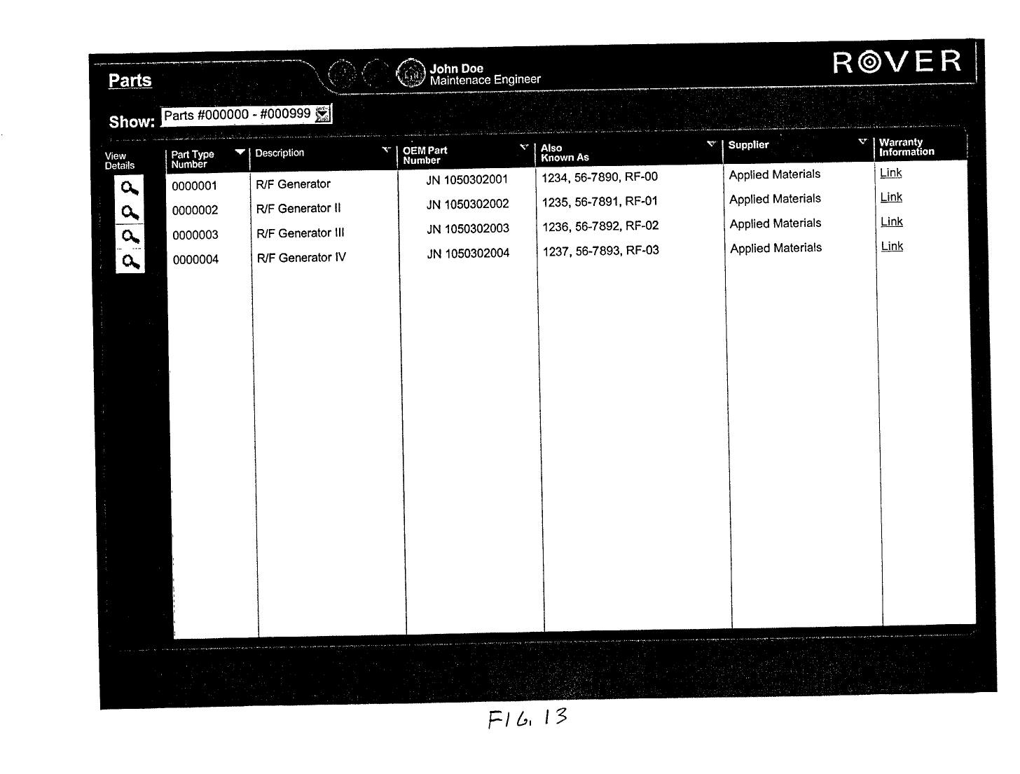

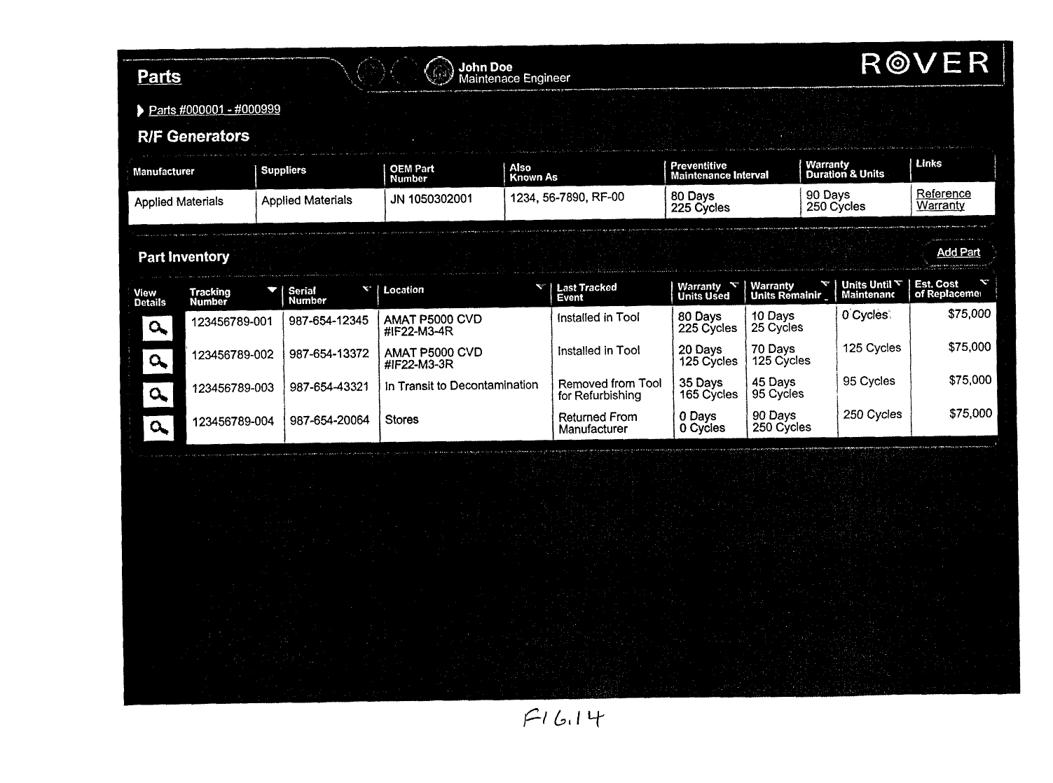

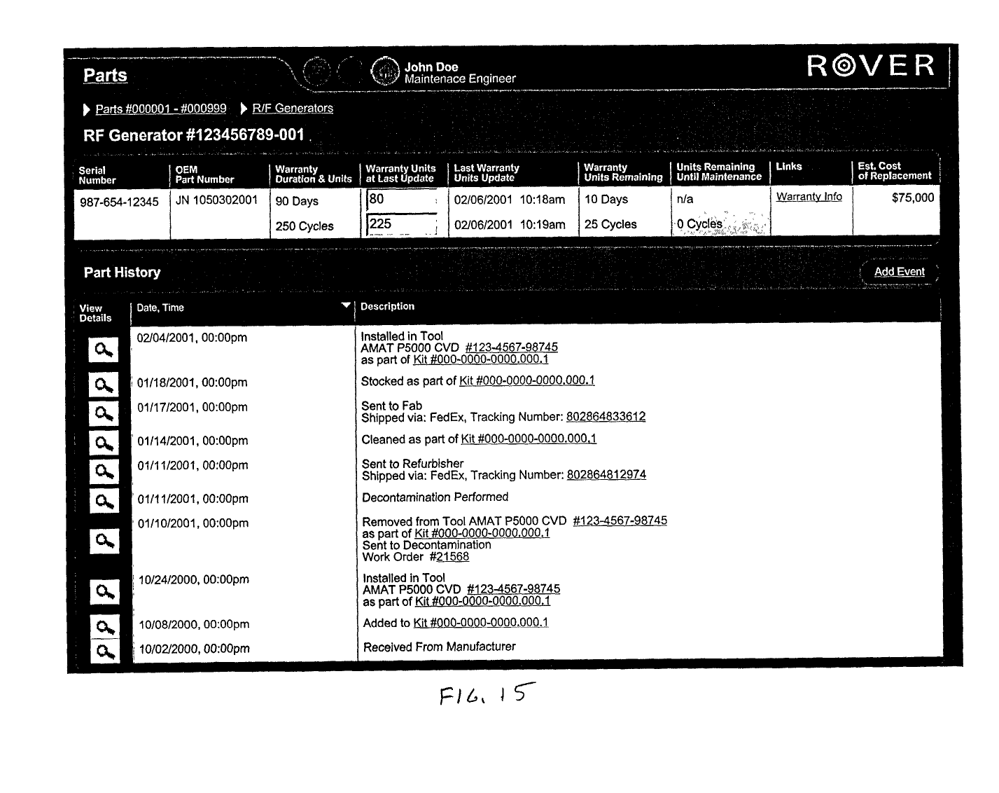

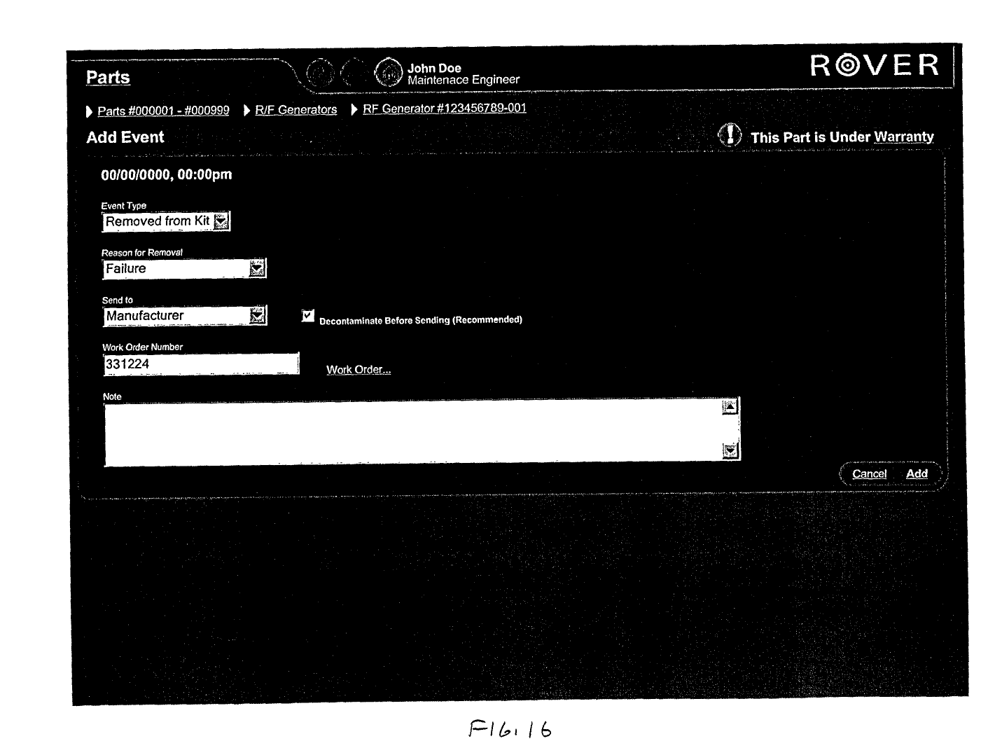

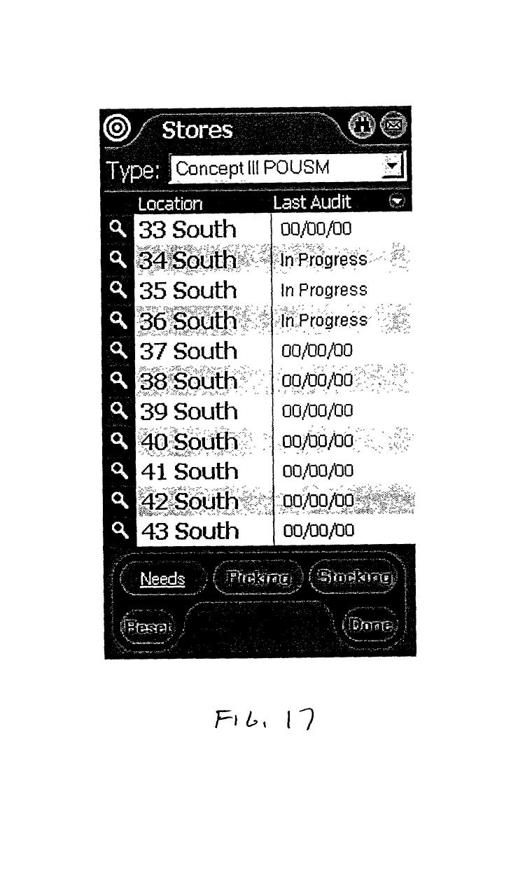

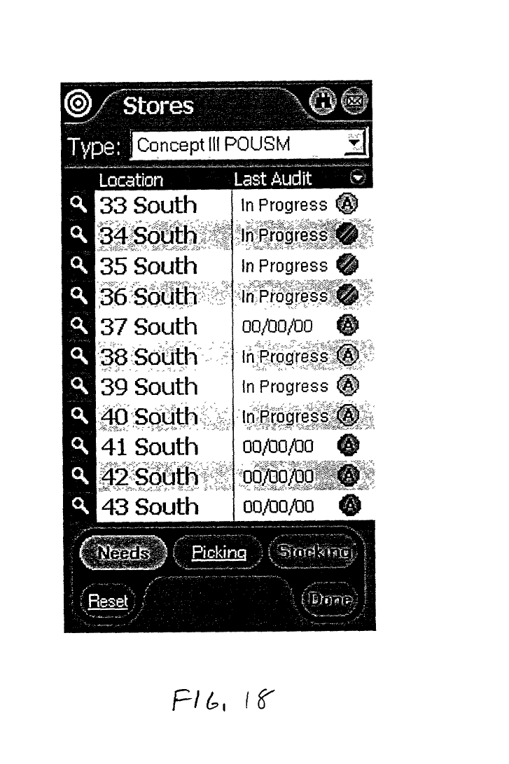

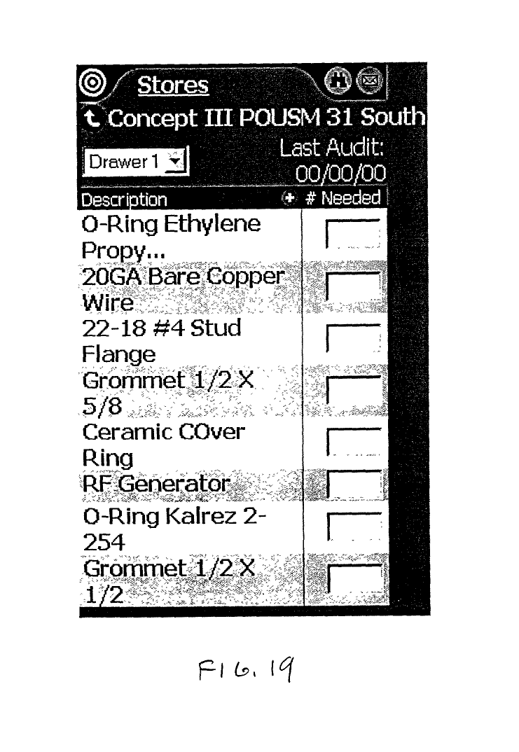

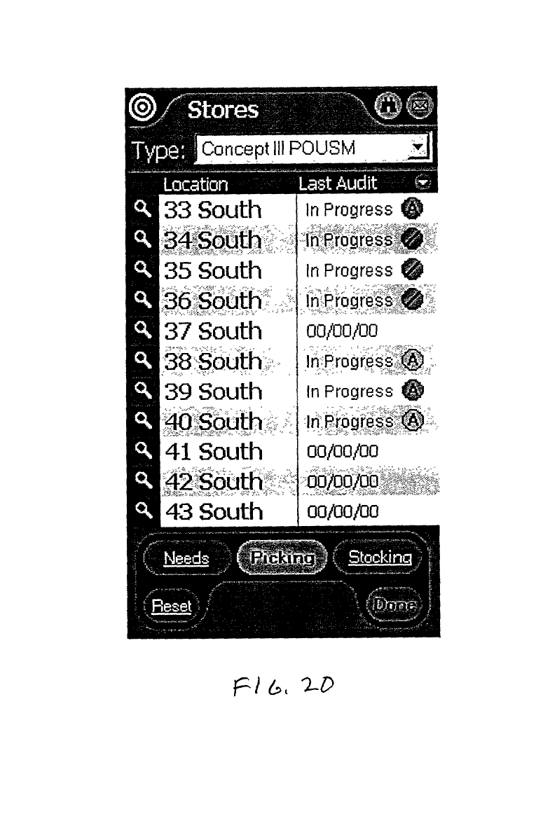

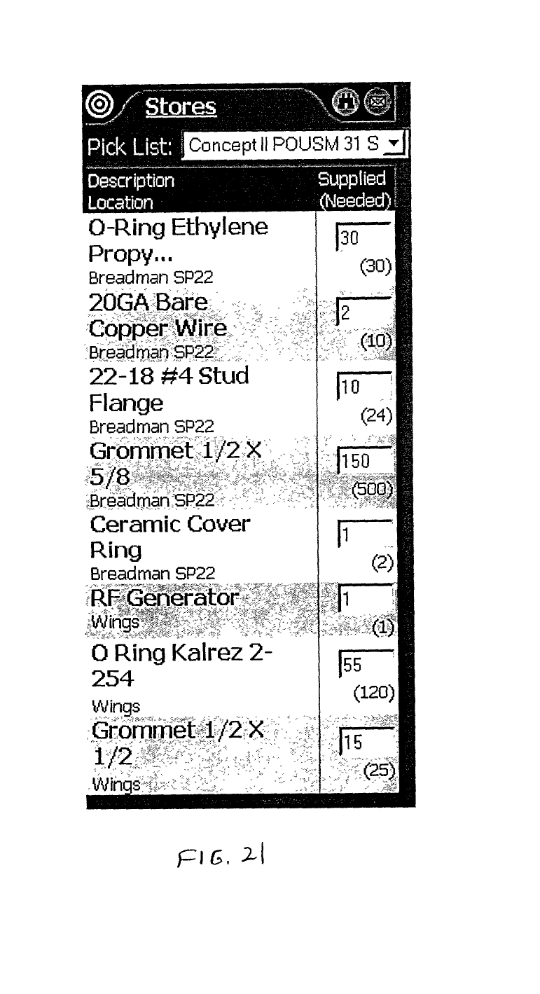

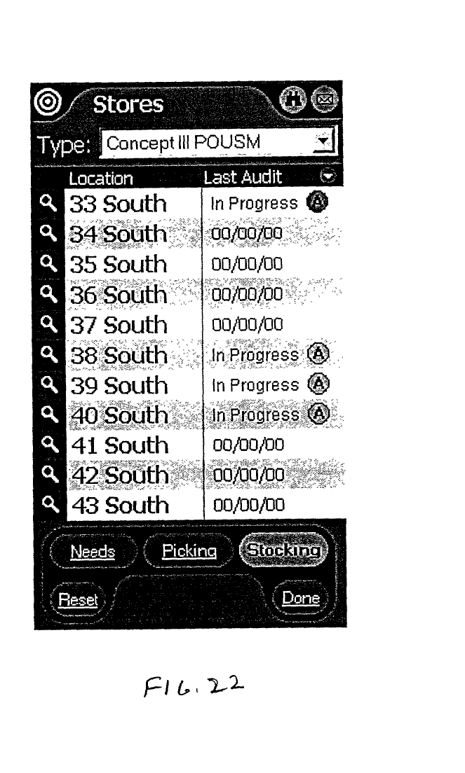

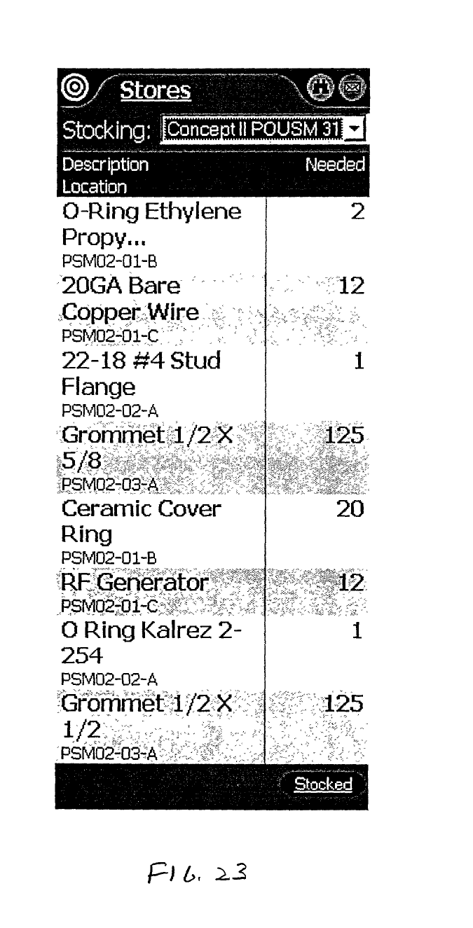

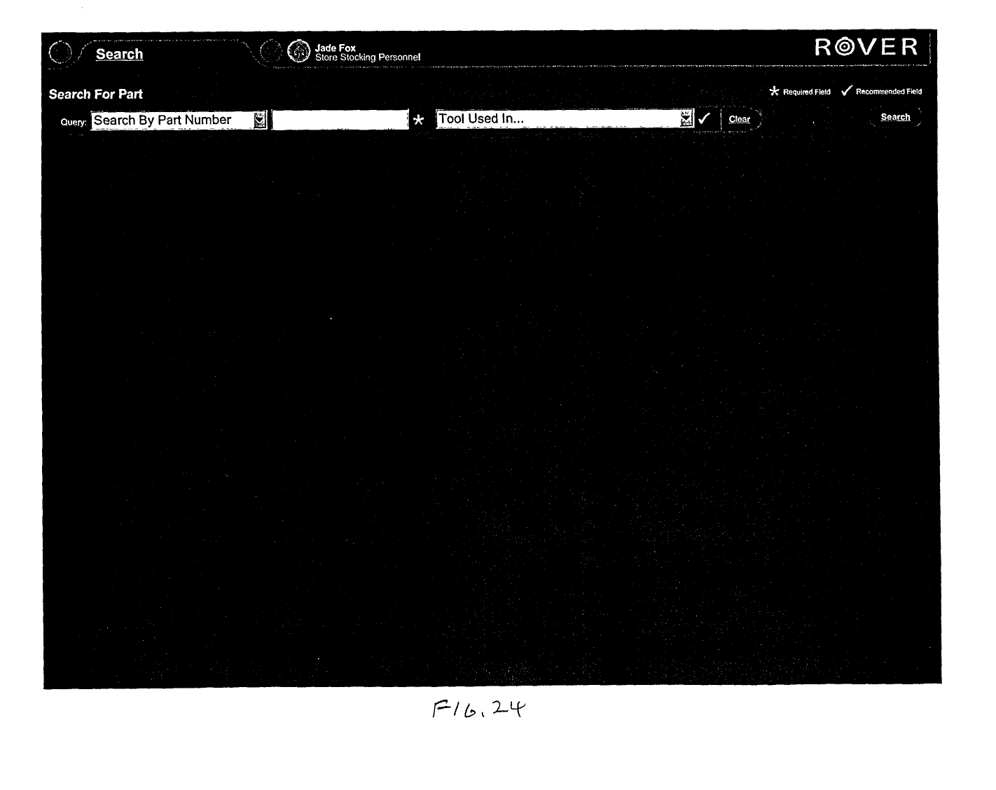

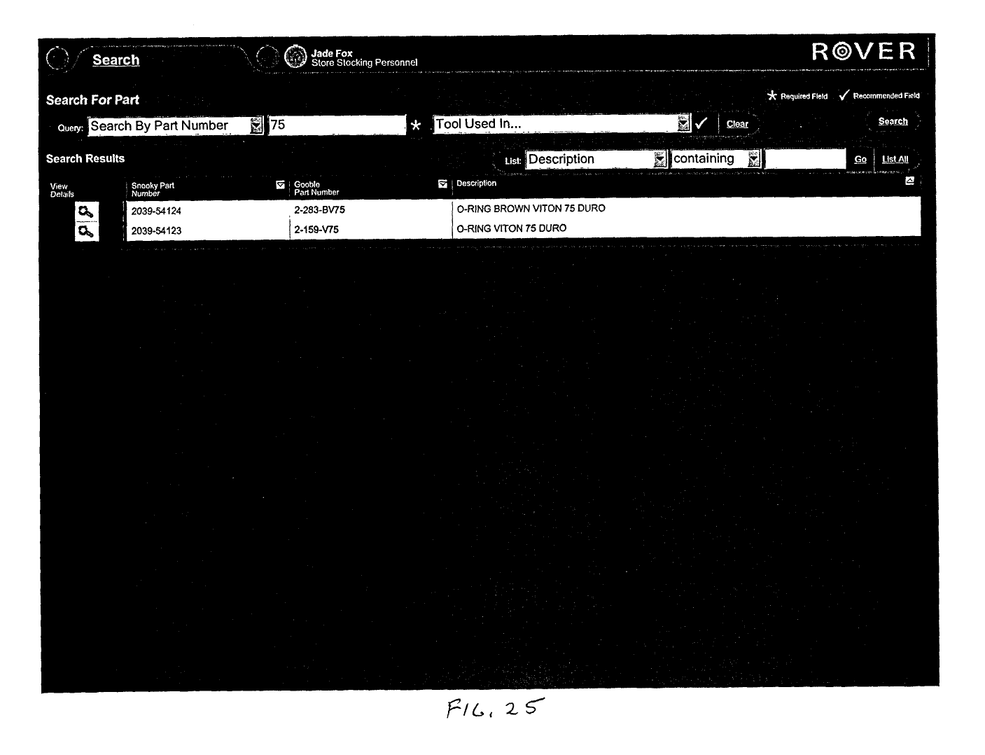

FIG. 2 is a block diagram illustrating the physical locations of different elements of an embodiment of the present invention. A typical foundry will have a clean room containing a number of tools 50. Also located in the clean room, or in other places, will be stores of parts 52. Externally, there are suppliers of parts 54. A decontamination area 56 is provided for refurbishment, cleaning and rework. This can either be part of the foundry, or at an outside contractor.

The database and software of the invention resides on a server 58, which is written as a web application. This can be accessed by browsers in PCs or PDAs. PCs may have different dashboards customized for the particular needs of different types of personnel. Shown is a supplier portal PC 60, a manager portal 62, a maintenance engineer portal 64 and an analyst portal 66. Similarly, there is shown a PDA 68 for monitoring the stores and doing auditing, picking and stocking. PDAs 70 and 72 may be used inside the clean room at a tool, such as for installation or removal of parts. Another PDA interface 74 can be provided for decontamination area 56. In one embodiment, the software is written with JAVA code and the interfaces are browsers written using HTML code.

1. Part Type Repository

1.1. Problem

In many chip fabrication plants parts are known by several different part numbers. For example, a single type of O-Ring might have a supplier part number, an equipment manufacturer part number (identifying it within a particular piece of equipment) and a plant part number (identifying it within the plant's part supply system).

Having several numbers can make it hard to find a part. Suppose a maintenance engineer is looking for a part to fix a piece of equipment, and his local store is empty. He may not know that the same part is used in a different piece of equipment, under another number. So his equipment may stay idle, at great cost to the plant, even though the necessary part is in a nearby store filed under a different number.

Also, manuals and specifications may use different numbers, making it hard for an engineer to find all the information relevant to a part. Though the information is available it can be very time consuming to track it down, which can have a big impact if the information is needed to fix an urgent problem.

1.2. Implementation Solution

The Rover™ Materials Management System of the present invention maintains a part type repository which maps multiple part numbers to a single master part number for each part. This master part number can be used to look up details of the part—its description, all known part numbers, warranties, manuals etc.

As the system is extended and new part information is added, master part numbers give a consistent way to cross reference part information. Over time the part repository can absorb information from many different sources (part manufacturers, equipment manufacturers, part maintenance companies etc.) and link it all together using master part numbers. Any part number for a part can be used to look up the master part number and hence to retrieve all relevant information for the part.

1.3. Key Benefits

The part repository allows users to search using any part number and access, via the master part number, all the information Rover Materials Management System has on that part. This will include the static information in the repository plus dynamic information collected by other Rover Materials Management System modules.

The static information will include the part description, other part numbers for the part, manuals, specifications, diagrams and other related documents. So no matter which part number the user knows, they can quickly retrieve all the relevant information for that part.

The dynamic information can be equally valuable. Master part numbers are used throughout the other Rover Materials Management System modules, so once the search has identified the master part number it can be used to look up anything the other modules know about the part. For example, if the store management module is used, Rover Materials Management System can say which stores stock the given part and how many of the part were present at the last audit. If parts of this type are usually refurbished and re-used then the Rover Materials Management System tracking module can show all the parts of that type in the plant, where they are and how they have been used in the past.

In the sections describing other Rover Materials Management System features it is assumed the part repository can be used to translate between different part numbers and to access static information about parts.

The part repository and master part numbers are also vital when building links into the Rover Materials Management System system, for example from equipment reference manuals or other applications that are used in the plant. Given the master part number for a part it is easy to construct a URL that will cause Rover Materials Management System to display details of the part (in all the detail mentioned above). Embedding this URL in a reference manual or other application makes it simple to link to all the Rover Materials Management System functionality related to the part. The details of these links are described in a later section on integration.

2. Rover Materials Management System Kit Manager Module

2.1. Overview

Semiconductor manufacturing tools require frequent maintenance, due to the harsh operational environment that chip making equipment is exposed to (high temperatures, abrasive chemicals and gases, powerful R/F radiation). Semiconductor manufacturing facilities (fabs) commonly use Kits as an integral part of their equipment maintenance process. Given the capital intensive nature of chip manufacturing, it is extremely important to streamline the equipment maintenance and repair cycle, in order to keep equipment idle- and down-time to a predictable minimum. Kits are perceived by fabs as an efficient and cost-effective mechanism to maintain the equipment (tools).

A kit consists of a durable, clean room compatible container which is uniquely labeled and identified (fab id, name, location, unique kit number). Kits contain a set of uniquely identified, trackable parts which are refurbished and re-used. They also contain a set of consumable parts, which are used once and then disposed. A kit will typically contain no more than a hundred parts, and can contain as few as one. While in transit or storage, refurbishable parts always remain in the same kit. The parts can be identified with a bar code on the parts themselves, or on a bag containing the part. The kit has its own bar code, which may be placed on the kit container.

In some applications, fabs run their own internal kit management service. In other applications, kits are provided by semiconductor tool manufacturers (e.g., Novellus, Applied Materials) as part of a maintenance service to their customers (e.g., fabs such as Intel, IBM). There are many different kit types, each tailored to a specific fab application. Fabs drive the exact makeup of a kit. Tool manufacturers typically support hundreds of different kit types for each tool type. The service agreement between the tool manufacturer and fab determines how many instances of each kit type will be supplied and stored at specific fabs. Large fabs may use 300-400 instances of a particular kit type.

Kits are tailored to very specific manufacturing processes, which can be as granular as a specific “recipe”, run in a specific chamber of a specific type of semiconductor manufacturing tool. It is extremely important to a fab to track the detailed and exact history and use of each kit and its individually tracked parts. Tool manufacturers face significant challenges in providing a comprehensive Kit management service to their customers. The challenges include:

Creating and managing many types of kits for many different fabs

Creating and managing many instances of each kit for each fab

Capturing and reporting on very fine-grained tracking details about kits and individual parts

Keeping an accurate and detailed history on the life cycle of thousands of kits and parts. In particular, fabs frequently misplace or lose valuable parts as they transition from OEM to fab to various refurbishing vendors.

Providing speedy, real time access to all the above information in order to satisfy the need for maintenance efficiency and immediate access to this data by fab personnel

There is significant need for a computerized kit tracking and management system that solves these challenges. The Rover Materials Management System Kit Manager addresses this need and fulfills the requirements, as described below.

2.2. Rover Materials Management System Kit Manager

Rover Materials Management System provides fab personnel or kit support personnel with an interface to create new kit types. Rover Materials Management System users can browse the master parts repository to select part types to be used in the kit, and determine the contents of a new kit type. Users may also clone an existing kit type and modify its contents to create a new one.

Rover Materials Management System provides an interface to create one or more kit instances of any given kit type. During this process, a Rover Materials Management System administrator configures the kit to include specific parts, chosen from the set of available parts at the facility or from the equipment manufacturer's inventory. For each part, the expected lifetime and maximum refurbish cycle count is noted (how many times a part may be refurbished or cleaned before disposal).

Rover Materials Management System also supports a more complex workflow, where fab personnel are allowed to create a “wish list” of parts for a new kit type. Kit support personnel review this wish list, filling out any details on new parts or OEM information as necessary, and approve/construct the actual kit type.

Once configured, a kit can be released into operation (or set to be released into operation at a predetermined future date), and its life cycle—as well as the details on its parts—will be tracked by Rover Materials Management System.

2.2.1. Kit Attributes

Rover Materials Management System supports any or all of the following kit attributes:

Fab identifier and location, e.g., Intel Fab 12

Tool type, e.g., Applied Materials Endura PVD III

Chamber number inside the tool (as defined by the Fab for this type of tool or manufacturing process)

Manufacturing process that is being run in the specified chamber, e.g., Pentium recipe #12

Additional, user defined labels or parameters as may be necessary to identify the kit, e.g., 500 R/F hours kit versus 1,000 R/F hours kit for the same chamber/process.

Primary kit refurbishing/cleaning vendor

Primary part coating vendor

Alternate refurbishing/cleaning vendor

Alternate part coating vendor

Kit refurbish cycle duration (expected turnaround time for a refurbished/replenished kit).

Kit price. The amount that a fab pays each time the kit is “used” (turns a cycle).

Additional attributes that need to be captured and displayed for a kit type, defined by the user as custom key/value pairs

2.2.2. Kit Part Details

For each part in the kit, Rover Materials Management System provides the following information:

Original Equipment Manufacturer (OEM) part number

Serial or tracking number (if it is a tracked, refurbishable part; not applicable for consumable parts)

Maximum part lifetime or refurbish cycle count: how many times a part should be refurbished/cleaned before disposal and replacement

Cost: how much this part costs the semiconductor tool manufacturer

List price: the published (semiconductor tool manufacturer) list price for the part

Additional, user defined metrics that need to be captured for specific parts. For example, R/F hours used by an R/F Generator in between maintenance/refurbish cycles.

Some of these kit part details are illustrated in FIG. 7.

2.2.3. Kit Life Cycle and Rover Materials Management System Implementation

Ready to use kits are stored in a known location in the fab.

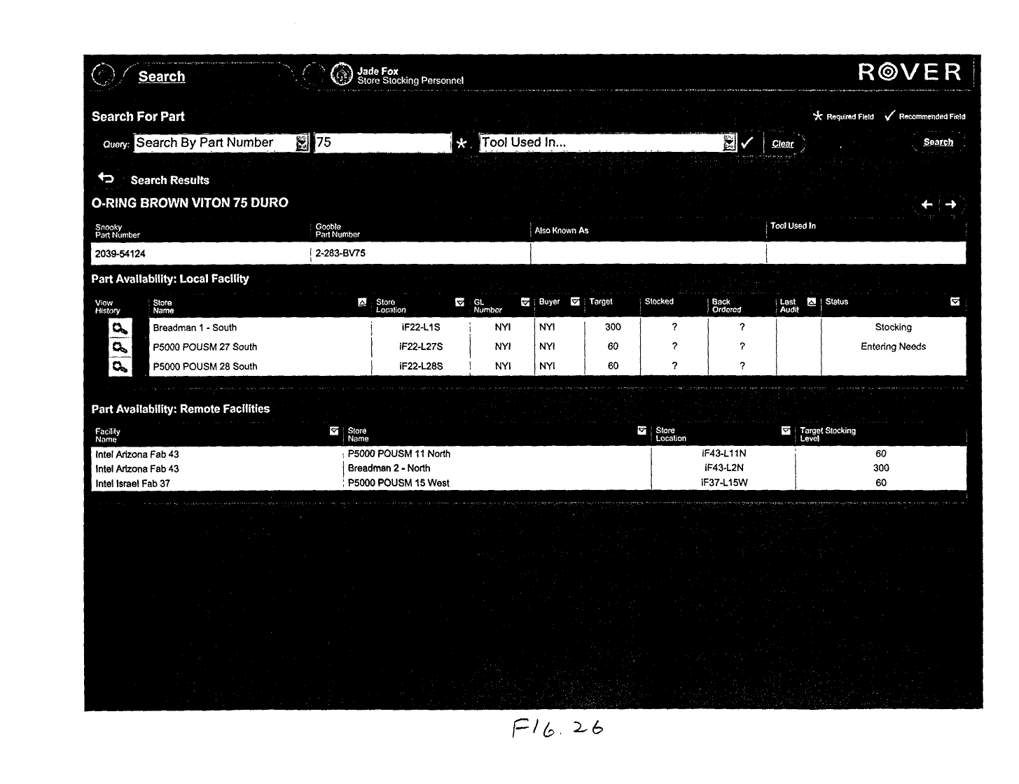

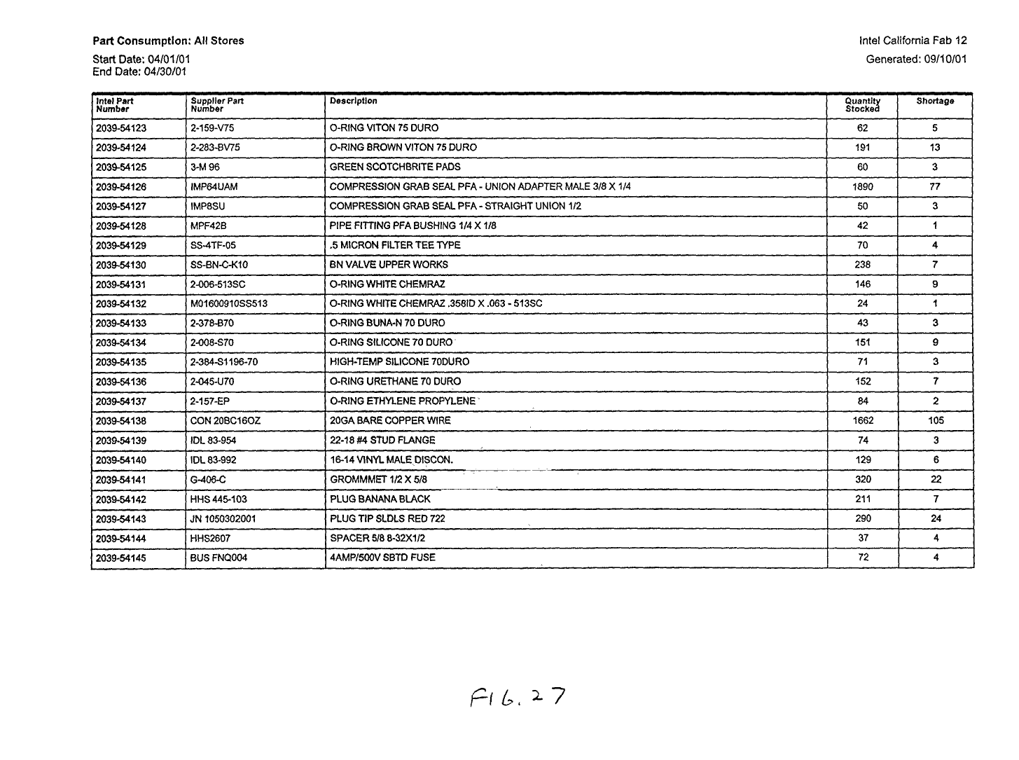

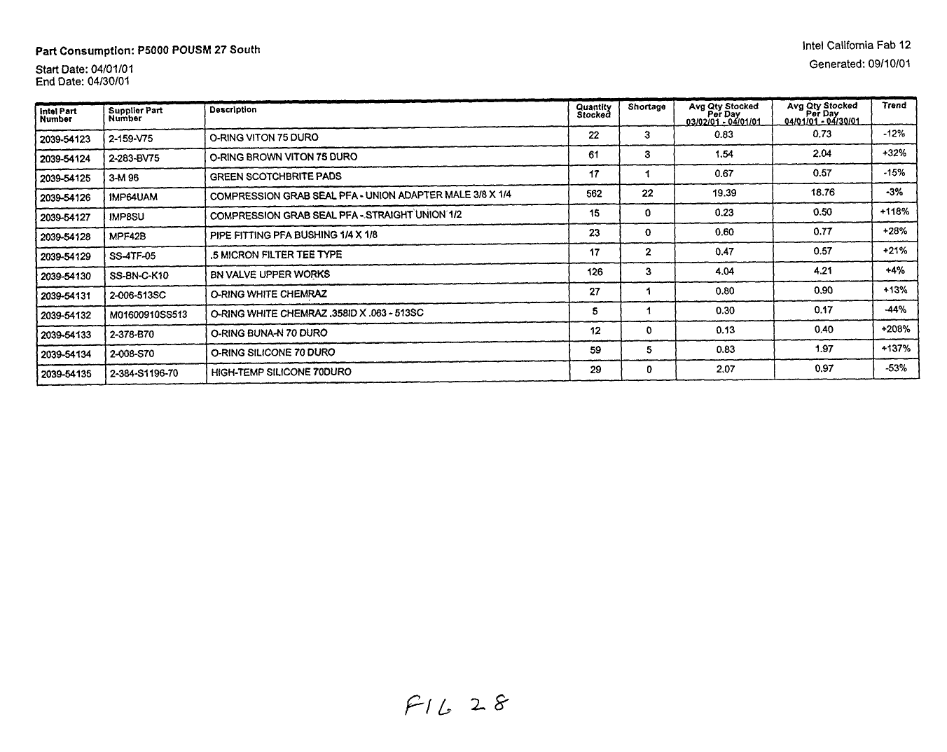

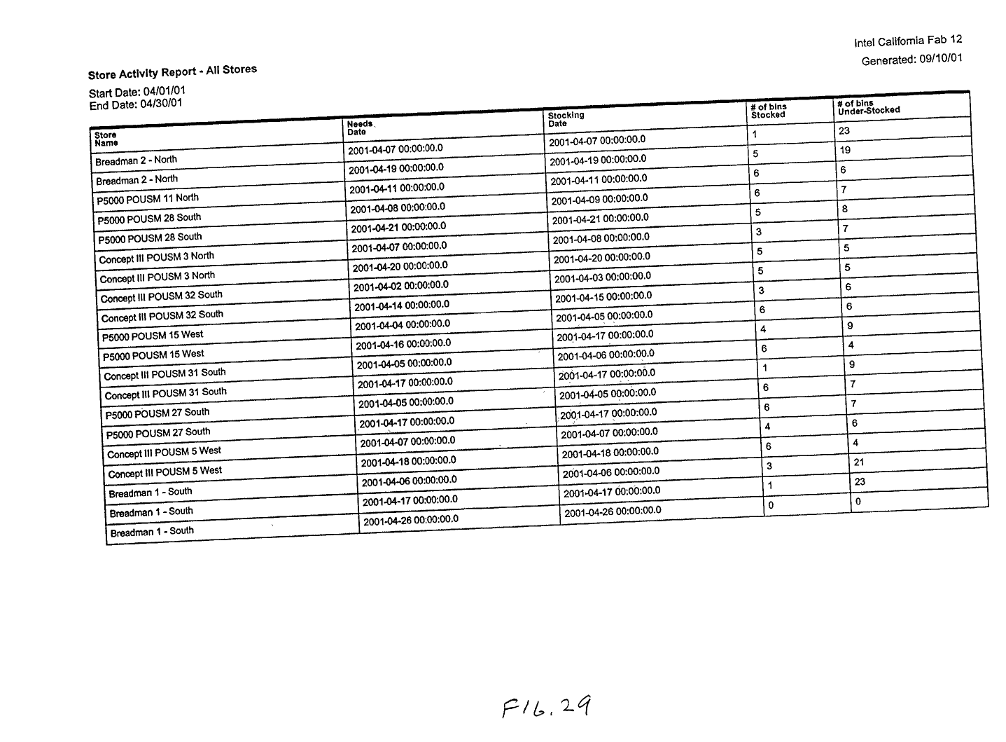

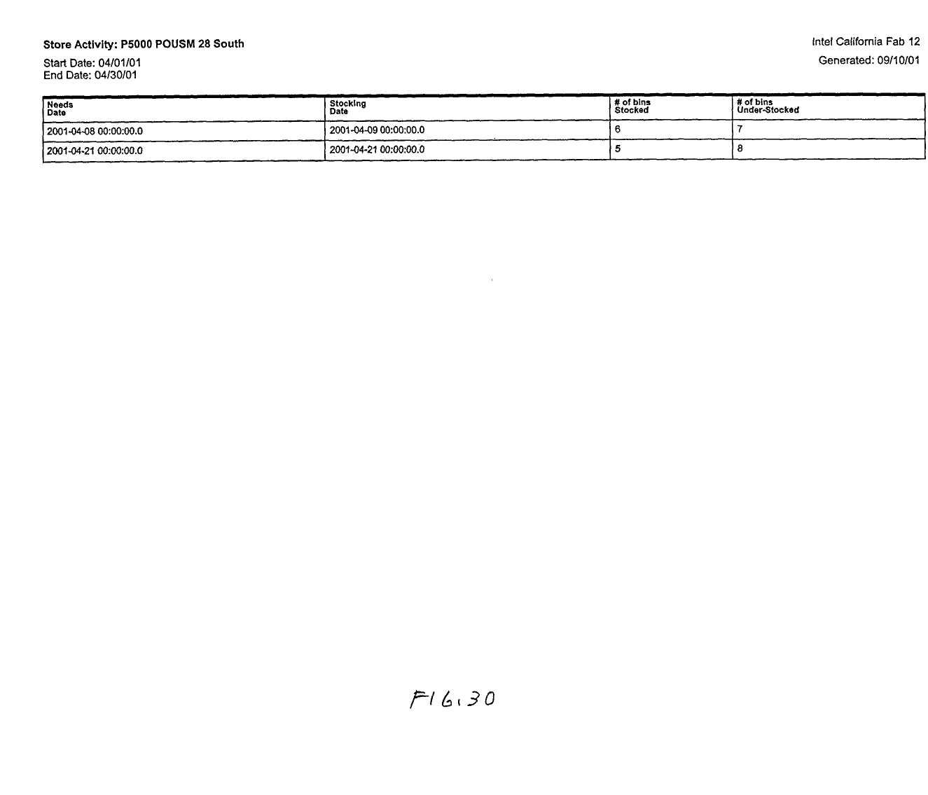

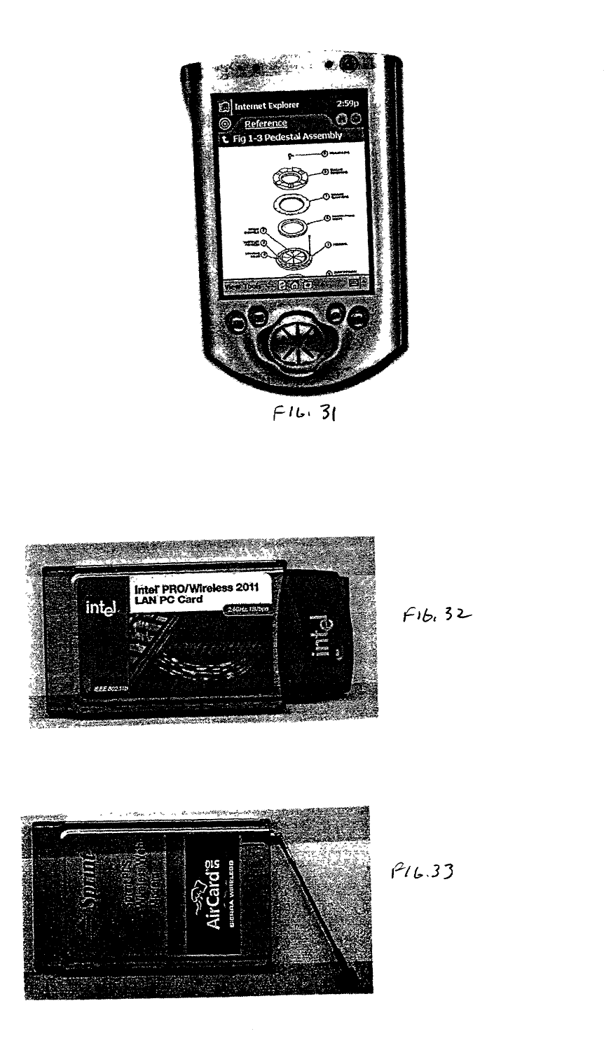

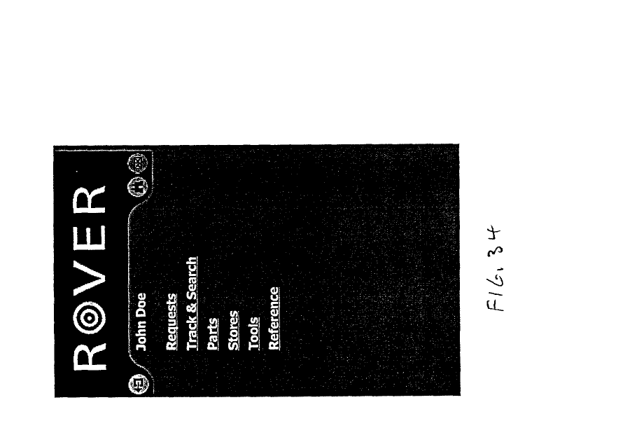

When performing maintenance on a tool, a maintenance engineer first removes all the appropriate used parts from the tool/chamber, and places them inside their kit container. S/he then takes the new/refurbished parts from the unused kit and installs them into the tool. The empty kit container is typically stored close to the tool until the next maintenance cycle, so that tracked parts always end up in the same container while they are in transit (a practice referred to by some tool manufacturers as “kit integrity”). FIG. 3 illustrates an example page that allows a maintenance engineer to locate and select a specific tool to perform maintenance on. FIG. 4 illustrates different kits that are installed in the selected tool. The Remove/Exchange button allows the selection of a specific kit. FIG. 5 illustrates the removal of the selected kit and installation of a new one.

When maintenance is complete, the engineer makes notes about the maintenance performed, and records some useful tool and part metrics. In practice today, some manufacturers attach a sheet of paper (“traveller sheet”) to the kit for this purpose. This information is typically read by the maintenance engineer from registers on the tool, and recorded on paper. The “Tool Cycle Counts” area of FIG. 5 shows 3 fields that capture the tool metrics. These values can be configured for each tool type by the Rover Materials Management System administrator. The values may be entered manually by the maintenance engineer, or updated automatically through the Rover Materials Management System semiconductor equipment adapter and interface.

On the next maintenance cycle, the engineer removes the parts from the tool, and places them in their corresponding kit. The kit is prepared for shipping to the refurbishing vendor, using the same interface as described previously (FIG. 5).

The refurbishing vendor receives the kit and cleans/refurbishes its parts. FIG. 6 illustrates an example page to capture this process. Note the detailed contents of the kit, including a part description, tracking number, refurbishing cycle count, and status for each part in the kit. During the refurbishing phase, Rover Materials Management System updates the refurbish cycle count for each part in the kit, keeping track of which parts have exceeded their expected lifetime. The status field for each part can be modified by the Refurbishing vendor as appropriate.

In some applications, certain kit parts need to be coated after refurbishing, and are sent to the designated coating vendor. When coated parts are returned from the coating vendor, they typically undergo another cleaning cycle. Then, they are placed into the kit. FIG. 6 illustrates how a refurbishing vendor tracks and changes the status of each part (Cleaned, Coated, Replenished, Expired).

FIG. 6 illustrates an example page for tracking a kit at a refurbisher, but this information is also available to the customer tracking the current status of the kit. The kit type is identified, along with a unique tracking number for the kit. The current location can be set forth, such as indicating it is installed in a tool or is at the refurbisher. The tool number is indicated if it is in a tool. The different parts of the kit are set forth in the description field, with their corresponding tracking numbers listed. More details about a particular part corresponding to a tracking number can be seen by clicking on icons adjacent the description. This will link to a part tracking page to be described below. A field “show” indicates that the current page shows kit parts. This field can be changed to display different pages relating to kits.

When part refurbishing work is complete, the refurbishing vendor attaaches a certificate of conformance for each refurbished part. Rover Materials Management System stores these documents in an online format, and they can be viewed from the part's maintenance history.

The refurbishing vendor updates and checks each part against its expected cycle count. Rover Materials Management System warns when a part has reached its maximum allowed refurbishing cycle count, and the old part needs to be disposed. A new part is placed in the kit, and the kit is updated with the new part details (e.g., serial number), as illustrated in FIG. 7.

The refurbishing vendor sends the refurbished kit to the support team. The support team checks the kit and its contents, replacing/replenishing parts as necessary, and prepares the kit for storage at the semiconductor fab.

The replenished kit is stored at the fab, ready for use.

Rover Materials Management System builds on the data captured during the kitting process to provide the following additional features.

2.2.4. Kit, Tool and Part History

FIG. 8 illustrates how the history and life cycle of an individual part inside a kit can be tracked. FIG. 8 shows a history for a part in a kit. On this page, a series of events are indicated by their time chronologically in fields “date, time.” The type of event is indicated in the “description” field. These events can include such things as being installed in a tool, stocked, being shipped to the refurbisher, etc. By clicking on the magnifying glasses, a user can view more details of a particular event. Such details could include, for example, the location of the kit for each of the particular events or the particular function performed during a refurbishing.

FIG. 9 shows how Rover Materials Management System tracks the kit installation history for any selected tool, allowing further drill-down into the contents of the kit, specific part numbers installed in the tool on each date, etc.

2.2.5. Reports and Forecasting

Rover Materials Management System can build reports from the kit tracking data. For example, based on historical kit usage data in a fab, it can estimate when kit parts will expire, and consequently forecast how many replacement parts will be required, and the associated details, as illustrated in FIG. 10.

Rover Materials Management System can also generate a report on kits used by a specific fab (or selection of fabs) for a given date range, as illustrated in FIG. 11. This information is required for a tool manufacturer to invoice its customers (fabs) for kit usage.

Using metrics captured during the tool maintenance cycle as described previously, Rover Materials Management System can provide additional reports on Tool and Part performance:

Mean Time Between Failure (MTBF) of a tool or the individual parts in a kit.

Mean Time Between Refurbish (MTBR): how long a part performs between cleaning/refurbishing. The duration could be measured in days/hours, R/F cycles, etc. depending on the part.

Mean Wafers Between Refurbish (MWBR): how many wafers were processed since the last refurbishing cycle.

Average Cost Per Wafer (ACPW), based on kit usage and Rover Materials Management System's knowledge of wafers produced in between each maintenance cycle.

2.2.6. Data Access by Role and User Id

All Rover Materials Management System modules have the ability to control functionality and data access on a per role and individual user basis. Each user interface page and report evaluate whether or not to display specific pages and data fields based on the role and individual user accessing it. For example, while Rover Materials Management System tracks detailed financial information about parts and kits, this information is only displayed to users who are authorized to see it. Rover Materials Management System provides an administrative interface to administer these access rights.

2.3. Key Benefits

Encapsulates the complete kit creation, administration, use, and refurbishing work flow

Kit integrity: tracking and accountability for all parts in a kit throughout their life cycle. Valuable parts are no longer misplaced or lost as they are moved between OEM, fab, and various refurbishing vendors. Rover Materials Management System makes it easy to track the location and status of each part.

Internet based system, allows real time and highly secure system access to authorized users from different companies and locations.

Fine-grained control over access to data, by role and individual user. Customized user interface pages and reports, displaying select data based on role and individual access privileges.

Rich historical data and reporting capabilities, providing targeted kit and part statistics.

3. Rover Materials Management System Part Manager Module

3.1. Overview

Semiconductor manufacturing is a complex process which involves hundreds of different tools in a fab, many of which have been customized and modified to perform a specific function or step in the manufacturing process. Tools require frequent maintenance due to the harsh operational environment that they are exposed to. Fabs typically keep high levels of consumable and refurbishable parts on hand (in local inventory) in order to meet the maintenance requirements and minimize the high expense and opportunity cost of idle or broken equipment.

3.1.1. Consumable Parts

Some spare parts are “consumable”: they are installed and used in a tool once, and then disposed of during the next equipment maintenance phase. They are typically lower cost parts, for example O-Rings.

3.1.2. Refurbishable Parts

Other parts are refurbishable: after they have been removed from a tool during maintenance, they are refurbished and cleaned. Once parts have been restored, they are returned to the fab inventory. Part performance data is vital in order to determine when a refurbishable part has exceeded its useful life span and should be disposed. Performance metrics vary depending on the part type, for example, they may be measured in terms of the number of R/F hours clocked by an RIF generator in between refurbishing cycles, or the number of wafers produced by the tool while the part was installed. Refurbishable parts are typically expensive parts.

3.1.3. Part Warranties

Some parts have a manufacturer's warranty that needs to be recorded and tracked. Warranties vary depending on the part type, and are sometimes somewhat complex. For example, a warranty for an R/F Generator may be expressed in 2 different types of units, such as a number of days from first use and/or a number of R/F Pulses used. Given the large number of warranted parts in a fab, the multi-dimensional nature of warranties, and the elaborate maintenance and refurbish history of parts, there are significant challenges to record, keep track of, and utilize all the warranty information. Currently, an evaluation of warranty compliance for each part is complicated and labor-intensive, and simply not practical without a sophisticated part tracking system. Fabs have identified under-utilization of part warranty agreements as a significant cost area.

3.1.4. Risk of Contamination

The semiconductor production process is very vulnerable to contamination. Small amounts of foreign elements can ruin a batch of wafers. While refurbishable parts can theoretically be installed in any tool of the same type, extreme care is taken to only install refurbishable parts in tools that perform a similar function or process. For example, a specific chamber in a tool can be dedicated to produce chips that use a specific metal, such as copper. Once this tool chamber has been dedicated to a copper process, the fab would never want to install refurbishable parts into this chamber that have been used in a production process using metals other than copper. Clearly, there are significant part tracking requirements to make sure that this does not happen.

If a batch of chips does get contaminated and damaged for some reason, it is extremely useful for fab analysts to quickly be able to trace the batch to a particular tool chamber, and examine the maintenance history to see if there are any parts that were likely to have caused the contamination. Furthermore, if a specific part or set of parts is deemed to be the culprit, it is very valuable to quickly discover which other tools in the fab may have had similar maintenance cycles and parts installed, to minimize any additional damage.

3.1.5. Part Life Cycle

The diagram below (FIG. 12) illustrates the generalized life cycle of a part in a fab. In practice today, due to the complex part life cycle and the lack of sophisticated part tracking systems, individual parts are often misplaced or lost, at a significant annual cost to the facility. FIG. 12 is a flow chart illustrating a typical part history. A part first appears in the inventory store database of the present invention, as indicated by box 140, from two sources. The part can either be requisitioned (142), or could be an identified warranted and refurbishable part (144) identified in a new tool (146).

The time when the part is installed in the tool (148) and when it is removed from tool (150), are entered and recorded. A part removed from the tool may be sent for cleaning/decontamination (152) or may be sent out for refurbishing to a supplier (154). A part which has exceeded the number of cleanings/refurbishings that are allowed, or is damaged beyond cleaning or refurbishing is then destroyed (156). A part can be refurbished or replaced (158) and then returned to the user with the date of receipt being input (160). The part is then returned to the stores (140) with the time of return being indicated. When the history information is added, it will appear in the part history shown in FIG. 8.

3.2. Rover Materials Management System Part Manager

Building on top of the part type repository, the Rover Materials Management System part manager provides tracking of individual parts. Starting from a view of the part type repository such as illustrated in FIG. 13, a user can click through to a part list page, showing specific instances of the selected part type in the fab.

3.2.1. Part List Page

FIG. 14 illustrates an example part list page, with a few details on each part. Full details of the part can be reached by clicking on a link. Part details include:

Part description

Fab part number

OEM part number

Part tracking number/serial number

Location (in tool, in store, at manufacturer)

Last tracked event (installed in tool, back from refurbishing etc.), including time event was entered.

Estimated dollar value

Warranty status (still under warranty/out of warranty), including time warranty information was last checked.

Time/cycles left until refurbishing required

The list can be sorted by any field and filtered on any field (e.g. show only parts that are out of warranty).

Suppose a Rover Materials Management System user in a fab sees an expensive part that has been removed before its warranty expired. S/he can then click on that entry to see details, and will be linked to the part details page.

3.2.2. Part Details Page

FIG. 15 illustrates an example part details page, which provides details on a particular part, and also lists its recent history—for example first installed in tool, then removed on a subsequent date, then sent to be refurbished, etc.

The details given on the page include:

Part serial number

Fab part number

OEM part number

Warranty/warranties—duration and units

Fields to update warranty units, for example to update the cycle count for the part

Dates when the warranty units were last updated.

Time/units remaining until part needs refurbishing

Links to warranty information, if available online

Estimated replacement cost of part

Number of times part has been refurbished

Part history, a list of events in which each event contains at least:

Type of event (install, remove, sent to be refurbished etc.)

User who entered the event

Date

Part location (if applicable)

This page could also include a “View other parts like this” link, which would take the user back to the parts list page, showing all the parts of the same type within the fab.

In the example illustrations provided, the user can look at the part that has been removed before its warranty expired and see why it was removed. S/he can also look at its past history and see if it failed early before it was last refurbished. S/he can compare the part's actual performance during a specific period against the manufacturer's performance guarantees and warranty terms.

The page includes boxes for entering the expired amount of the warranty duration as of the last update. The update can either be entered manually, or may be electronically provided from registers in a tool-monitoring chip. From this information, the remaining warranty units are set forth, along with a link to a warranty information diagram and an estimated cost to replacement. Also shown is a part history which shows such events as the installation, stocking, and shipping of a particular part for initial installation and subsequent decontamination or refurbishing.

3.2.3. Part Refurbishing Process and Workflow

The Rover Materials Management System part manager encapsulates the complete part refurbishing work flow, using the part refurbishing engine as described in the document “Rover Materials Management System Kit Manager Module”.

3.2.4. Reports, Alerts and Shortcuts

Rover Materials Management System builds on the part data captured to provide sophisticated part related analysis and reporting features, including the following reports and alerts:

Parts due for refurbishing

Parts removed from tools while still under warranty

Parts removed from tools earlier than expected

Parts away being refurbished that have been away more than the expected time

Tools in which a part is being replaced more frequently than expected

Parts for which there has been no new information for a long time

In addition, Rover Materials Management System can provide shortcuts to facilitate part tracking related work, for example it can:

Show all installed parts that are nearing the end of their warranties

Show all parts that are away being refurbished

Show all parts that have been removed from tools but have not yet been sent for refurbishing

Show all parts in the stores

3.3. Key Benefits

Efficient management of refurbished parts, throughout the complete part refurbishing work flow

Accurate and detailed tracking of each individual part: minimize misplaced or lost parts

Detailed tracking for all parts under warranty: maximize return on investment for warranty agreements

Determination of a specific part's performance, and performance comparison of equivalent parts from different manufacturers.

For a semiconductor fab, the above benefits result in effective inventory management, increased operation efficiency, and significant cost-savings.

4. Store Management

4.1. Process

Some chip fabrication plants use a “point of use store management” or POUSM program. In this program, spare parts for the equipment are kept in stores right next to the equipment (the “point of use”). In addition there are a few central stores that stock all the parts used in the POUSM stores.

When maintenance engineers need a part to fix a piece of equipment they can usually go to their POUSM store and get it. If the POUSM store doesn't have it they can go to the central store. This “free flow” system keeps things simple for maintenance engineers usually the part they need will be close by and they can just take it, without having to log on to a computer or fill out forms.

4.1.1. Stocking Stores

Keeping the POUSM and central stores stocked with enough parts is vital, and is usually done by specialized store stocking personnel. Each store has a “target stocking level” for every part it contains and store stockers will audit the store regularly to make sure it is adequately stocked. POUSM store audits are done as follows:

The store stocker gets printed “needs lists”, one for each POUSM store. These lists describe the contents of the stores and give target stocking levels for each type of part.

The store stocker visits each store and checks if any parts are below their target stocking level. If so he marks the number required on the needs list.

The store stocker now has “pick lists”—the original needs lists marked with the number of new parts needed. He takes these lists to the central stores, gets the parts he needs and puts them in a tote. Some central stores may be computer controlled inventory systems, others may be rather like large POUSM stores, with free flow access.

The store stocker takes the tote full of parts round the POUSM stores and stocks them

If any of the large central stores are free flow access they will have their own target stocking levels and will be audited in turn, using a similar process. It can be seen that keeping the stores stocked is important and labor intensive—it is sometimes sub-contracted out to a specialist company who will be judged by how well they keep the POUSM stores stocked.

4.1.2. Disadvantages of POUSM Stores

Though the POUSM store approach is very convenient for maintenance engineers, there are a couple of disadvantages:

The auditing process is manual and error prone. All the stocking information is entered on paper and has to be re-entered manually when parts are ultimately requisitioned from an on-line system.

No one knows where parts are distributed. The store stockers don't keep track of which parts go to which POUSM store. And maintenance engineers don't always know where parts are. For example, a maintenance engineer might need a part that has run out in his local POUSM store and the central store. There could be dozens of the part in a POUSM store just down the hall, but he would have no way of knowing they were there.

Rover Materials Management System helps with both these problems.

4.2. Implementation

Rover Materials Management System gives online support for auditing stores, so each stage of the audit is saved in a database. This simplifies auditing and also builds up an on-line record of where parts went. This record can be queried to find out where a given part is available or, over time, to find out how many parts of a given type are consumed in different parts of the chip fabrication plant.

4.2.1. Auditing Support

The Rover Materials Management System interface for auditing stores is available on a PDA, connected to the Rover Materials Management System server via a wireless network. Stocking personnel can use the auditing interface as they walk around the plant doing the audit, which eliminates “double entry” (writing things down on paper only to enter them into a computer later on).

FIGS. 17-23 show the auditing interfaces. FIG. 17 shows a list of POUSM stores and the current audit state. Suppose a store stocker is starting an audit:

The store stocker will click on the “Needs” icon to start collecting needs. The list will now look like FIG. 18.

The store stocker will go to a POUSM store and click on the “Needs” icon to start collecting needs for the store. This will bring up the needs entry page (FIG. 19). The store stocker will add how many parts are needed for each drawer (or other sub location) in the store, then return to the store list and move to the next store. This step is repeated until needs have been collected for all stores.

The store stocker returns to the store list and clicks on the “Picking” icon. The store list will now show all the stores that need parts (FIG. 20). The store stocker can go to the central stores and, for each POUSM store, bring up a “pick list” (FIG. 21) showing how many parts are needed, and which central store to get them from. If the central store is computer controlled, and has a network interface, Rover Materials Management System can connect to it an order the parts directly. If it is a “free flow” store the store stocker can just pick out the parts. In any case, the store stocker picks the necessary parts and puts them in a tote, ready for stocking.

The store stocker returns to the store list and clicks on the “Stocking” icon. The store list will then show all the stores that need stocking (FIG. 22). The store stocker will go round all the POUSM stores, stocking them with parts from the tote. For each store Rover Materials Management System can show which parts are needed via a stocking list (FIG. 23).

The audit is now complete. The store stocker clicks the “Done” icon on the store list.

Rover Materials Management System stores all information entered during the audit. This gives it a database of which parts went to which POUSM stores. Rover Materials Management System builds on this audit database to provide the following features.

4.2.2. Part Availability Search

Maintenance engineers looking for a part can use the Rover Materials Management System search screen (FIG. 24) to find out whether it is available. They can enter a partial part number or description and will be given a list of possible matches (FIG. 25). Note that because of the part repository mechanism they can enter the part number they know and will get results even if the part is known by other numbers elsewhere. If they drill down on a particular part in the result list they'll be given a list of places where the part may be available (FIG. 26). Because of the free flow model you can never be absolutely sure a part is available, but the store audit database can tell you how many parts a store should have, and when the store was last audited. Drilling down further on a particular store gives the audit history of the part within the store—how frequently that part has been restocked, and how many parts were needed.

4.2.3. Reports

Rover Materials Management System can build reports from the audit database. For example it can show how many of a given part have been consumed in the fabrication plant, and break that information down by POUSM store (FIGS. 27 and 28). This can highlight POUSM stores which have unusually high part consumption—presumably because the equipment they service is misbehaving.

Rover Materials Management System can also show auditing history for the entire fabrication plant (FIG. 29) or for individual stores within the plant (FIG. 30). This gives managers hard numbers about how often stores are audited and which stores are most active.

4.2.4. Other Interface Features

In FIG. 18, the particular page selected is determined by clicking on either the “needs”, “picking”, or “document” icons at the bottom of the page. The right column in FIG. 18 shows different icons, either a slash or an “A” of different colors to indicate the status. A slash can indicate that an audit is in progress. On other pages, a slash may indicate that no supplies are needed, for example. The “A” of a first color, such as gray, can indicate a store where needs have not yet been entered, while an “A” which is another color, such as yellow, can indicate those for which the needs have been entered.

FIG. 19 illustrates a drill-down by clicking on one of the magnifying glasses for more detail on one of the stores locations of FIG. 18. Boxes are provided to enter the number of parts needed adjacent to each part. A stocker auditing a store can enter the number of parts needed, rather than using a paper list. This data immediately updates the database, and is available to everyone with access to the database.

FIG. 21 illustrates a “pick list” page for a particular store. The pick list displays in the right hand column, in parentheses, the needs indicated by filling in the screen of FIG. 19. The stocker can then fill in the actual number the stocker is able to pick out of the store to fill those needs. In some cases, that number may not match if there are insufficient supplies to provide the requested need.

Upon the entering of data, the underlying database is updated, so that any other user can instantly see the correct status of inventory in particular stores for particular parts. The system can prepare a summary of the shortages, and automatically fill out and send a request to a purchasing person. This can be automatically generated upon a shortfall occuring, or the stocker could trigger the request. The request can be accessed by a number of people in different formats. It can appear on a to-do list for the purchaser, and in a report for an analyst.

4.3. Key Benefits

By supporting stores management Rover Materials Management System provides the following benefits:

Easier auditing, with less error prone data entry

Part availability searching, which can reduce equipment down time by finding a vital part that is out of stock in the local POUSM and central stores.

Parts can be requisitioned electronically from other inventory control systems

Reporting on which parts went where in the fabrication plant, and the ability to compare part consumption between different stores, and between a store and average or historical trends.

Detailed reporting on auditing activity within the fabrication plant.

5. Rover Materials Management System PDA and Desktop Versions

5.1. Overview

Rover Materials Management System modules communicate with Wireless PDAs, providing immediate and complete access to data and functionality of the Rover Materials Management System system from anywhere in the facility. Rover Materials Management System provides a PDA interface for almost all functionality available on the desktop. Where required, details are omitted from PDA screens due to form factor limitations.

The current PDA version of Rover Materials Management System is implemented as a web-based application, using Microsoft Internet Explorer on the PocketPC platform as the web client. The PDA can be configured with a barcode scanner, to facilitate inputting barcode information from tracked parts, tools, kits, etc. The barcode reader also minimizes operator data entry errors, for example, when registering new tracked parts in the system. The PDAs are typically configured with a Wireless network card, such as those based on the IEEE 802.11b standard. Rover Materials Management System supports any kind of TCP/IP based wireless networking standard. For example, Rover Materials Management System can be accessed from a PDA through a true wide area network (WLAN) based on wireless cellular communications such as those offered by wireless telephone carriers; or through a PDA configured with an IEEE 802.11a standard wireless networking card, which will be commercially available in November 2001.

FIGS. 31-33 illustrate the Rover Materials Management System interface on a sample PDA, and two different types of wireless network cards

5.1.1. PDA Interface

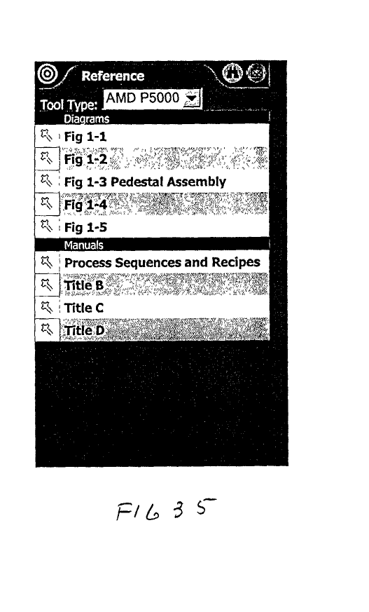

FIGS. 34 through 40 illustrate a Rover Materials Management System Reference application, where a maintenance engineer starts browsing an online manual for a tool and links to Rover Materials Management System for specific part information and availability.

FIG. 34 illustrates one embodiment of a home page for a PDA device with a listed table of contents. The pages accessed by clicking on the different names are shown in the following figures.

A “request” page comes up when the request item is clicked on the page of FIG. 34. This can show either a list of requests sent to the user, or from the user, and shows both the status and the type. The type of request can indicate the urgency of the request, such as where the store is empty (0 bin) to where the tool is down and needs the part (0 bin, tool down). Less urgent demands include a simple “stock request” and “stock<demand”. An example of a type of request is “0 bin tool down.” When the user goes to a local store, such as a BreadMan indicated in a store location field, and finds no parts or an insufficient number of parts, the request form can be used. A part number is input, either by typing in or scanning the drawer for the parts, or the parts themselves. The particular tool for which the part is needed is indicated. The number needed is indicated. The addressee of the request is then set forth. Additionally, for urgent requests, an e-mail or a pager notice can be sent. The request will then appear in a “request to me” field on a display for the recipients.

The “track & search” icon of FIG. 34 accesses a page for tracking a part. The tracking code can be either entered by typing or tapping it in, or can be scanned with a scanner attached to the PDA device. If the tracking icon is then clicked on, a tracking page will be displayed. This will shows the tracking number and the part, serial number and other information such as its current usage duration and the amount remaining before expiration of the warranty. Clicking on the “view part history” icon will bring up the part history page. This shows the history of where the part has been.

When the “parts” icon is clicked on, a page comes up allowing a particular type of part to be selected in a “type” field. For a particular location indicated, a list of the store locations where the part can be found, along with the number of parts as of the last audit date is provided.

By clicking on the “tools” icon of FIG. 34, and indicating a particular tool in a type field, the location of all tools of that type are shown, along with the last maintenance data.

5.1.1. PDA Reference Module

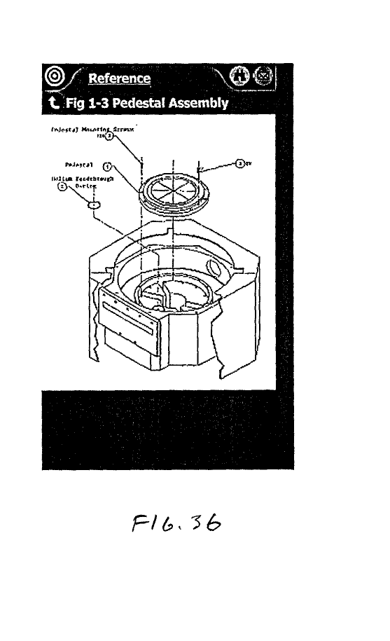

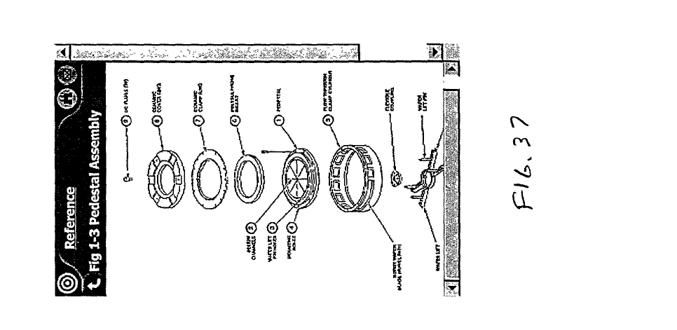

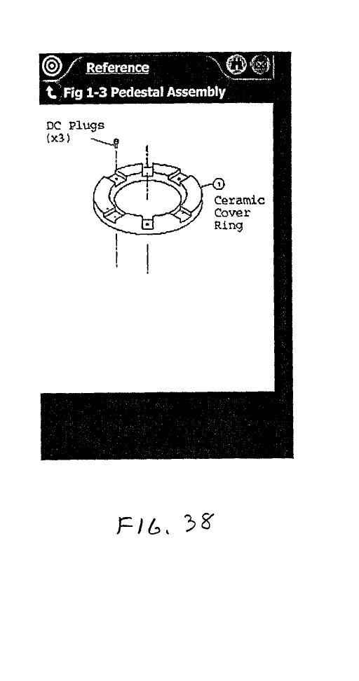

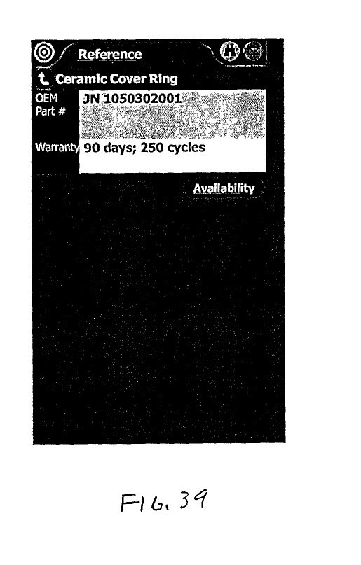

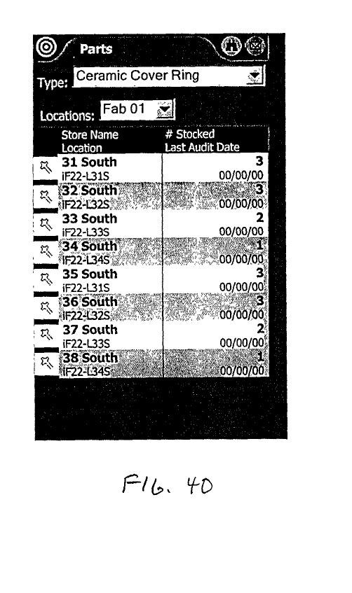

Clicking on the “reference” icon of FIG. 34 will bring up the page shown in FIG. 35. This lists, for an indicated tool type, different diagrams and on-line manuals. FIG. 36 illustrates the page brought up when the icon “FIGS. 1-3 pedestal assembly” of FIG. 35 is clicked on. This shows a labelled diagram of a pedestal assembly. Clicking on a particular part will result in further detail, such as set forth in the example of FIG. 37. Still further detail is provided as indicated in FIG. 38. Clicking on the part of FIG. 38 will result in linking to the database from the figure to provide part number and warranty information for a particular part in the diagram, as shown in FIG. 39.

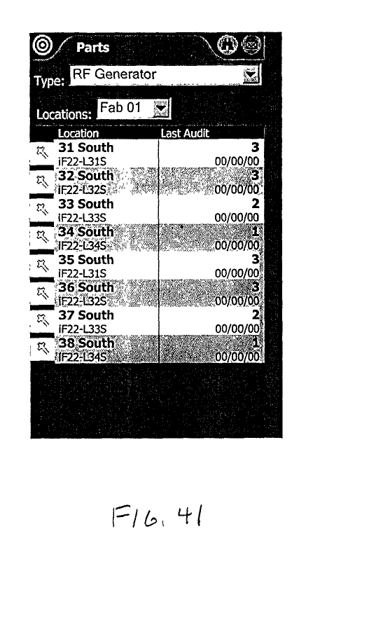

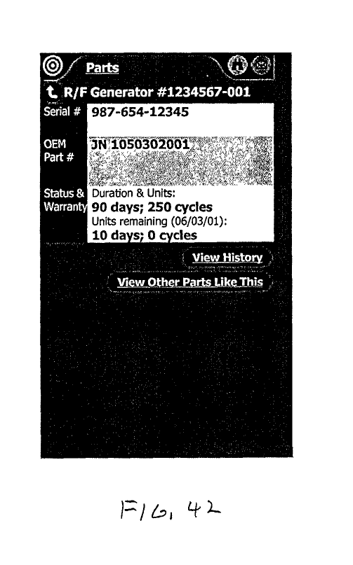

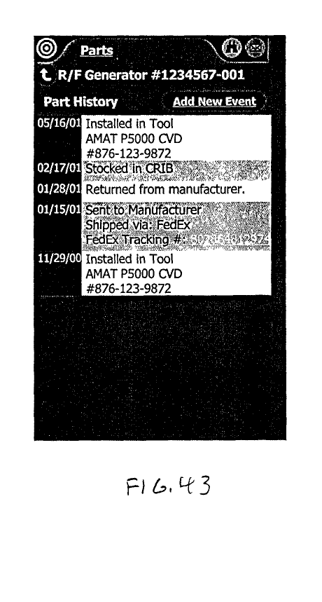

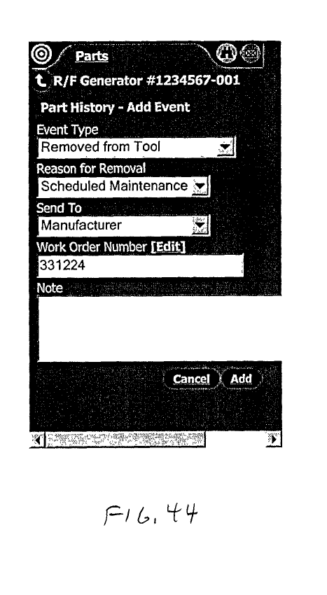

Further clicking on the “availability” icon of FIG. 39 will produce the page of FIG. 40 indicating the availability of the particular part clicked on. Note that the part type is automatically filled in and the user only has to specify the particular location. An example for another part is shown in FIG. 41. Further details on the part at the particular location can be drilled down to from this page as illustrated in FIGS. 42-44. Thus, a close link is provided between (1) the on-line manual and figures and (2) the parts tracking system of the present invention. This is just one example of how the parts tracking system can be integrated with other systems.

Other systems to be integrated with the system described herein, such as publishers of online manuals, can specify links, such as from an element in the manual to various functions of the tracking system described herein. For example, a semiconductor tool manufacturer can publish the reference manual for their equipment in an online format such as Adobe Acrobat. By using a URL specification set forth by the manufacturer of the tracking system herein, they can link specific part descriptions in the manual to online tracking features, e.g., they can link a part description or specific “hot spot” in a technical diagram directly to the tracking system (installed either at a tracking system manufacturer host or at the local semiconductor production facility), showing specific details about that part as it pertains to the local facility, such as the availability of that part in various “stores” inside the fab, or the serial numbers of all parts of that type used in thefacility, etc.

a. URL specification for marking up online manuals

b. Linking mechanism to map this URL to invoke a specific function of the tracking application; the ability to branch out (invoke other tracking features relating to the part) from there.

This URL linking feature can be used for:

a. Equipment manufacturers can publish all their online manuals using this specification.

b. Product manufacturers using the equipment (tools) can use the integrated system to quickly guide them from a part description to relevant local facility information about that part. For example, an Intel Maintenance Engineer at Arizona Fab 12 can browse the online manual for an Applied Materials P5000 tool, locate the section of the manual on the Ceramic Cover Ring they are interested in, click through on the part, and transfer this context to the tracking system, which will provide specific links such as the availability of this type of Ceramic Cover Ring at all local Intel Fab 12 Stores, or a list of all the serial numbers (tracked parts) of this type at this fab with their warranty information, etc.

The URL specified to the on-line manual publishers can have two components—a base URL to point to the tracking system, and a specific URL to point to the particular part. The base URL could be imbedded in the manual using, for example, a feature of Adobe Acrobat that allows such a base URL to be imbedded just once on the page. Then, only the specific portion of the URL relating to the particular part need be imbedded where the part is described.

5.1.3. PDA Part Manager Module

FIGS. 41 through 45 illustrate the PDA version of the Part Manager, as discussed in greater detail in the section entitled “Rover Materials Management System Part Manager module”.

### CONCLUSION

As will be understood by those with skill in the art, the present invention may be embodied in other specific forms without departing from the essential characteristics thereof. For example, other software languages could be used to implement the invention, along with different interface devices. Also, different combinations of links or information could be provided on different combinations of pages than the particular pages set forth above. Accordingly, the foregoing description is intended to be illustrative, but not limiting, of the scope of the invention which is set forth in the following claims.

What is claimed is:

1. A method for electronically tracking parts comprising:
providing a single description of each part type in a central repository module;
providing a master part number corresponding to said part type; and
providing links, with said master part number, to modules containing dynamic information about said part type.

2. The method of claim 1 wherein said central repository includes a listing of alternative part numbers for said part type.

3. The method of claim 1 wherein said central repository includes a link to an online manual for said part type.

4. The method of claim 1 wherein certain of said part types are reusable parts, and further comprising providing a link to information tracking the maintenance of said reusable parts.

5. A method for electronically tracking kits having a plurality of parts, at least one of said parts being reusable, comprising:
assigning an ID to each kit;
assigning a part number to each type of the parts in each kit;
assigning a tracking number to reusable parts; and
tracking the maintenance of said reusable parts.

6. The method of claim 5 wherein said maintenance includes cleaning and refurbishment.

7. The method of claim 5 wherein said kits are used for maintenance of tools, and each kit is further identified with a tool ID.

8. The method of claim 5 further comprising establishing new kit types by:
assigning a new kit ID number;
identifying part types that constitute said new kit type.

9. A method for electronically tracking parts comprising:
providing a single description of each part type in a central repository;
providing a master part number corresponding to said part type;
providing a first list of parts in a first store, each of said parts being linked with said master part number to a description in said central repository; and
providing a second list of parts in a second store, each of said parts being linked with said master part number to a description in said central repository, at least a portion of said parts in said second store being the same as parts in said first store.

10. The method of claim 9 further comprising:
providing a needs list for said first store;
providing a pick list for said second store, corresponding to parts picked from said second store for stocking in said first store; and
providing a stocking list for said first store, for indicating which parts picked from said second store have been stocked in said first store.

11. The method of claim 9 wherein said lists are provided on a browser on a hand-held device, and a URL links said lists to said descriptions in said central repository.

12. A method for electronically tracking warranty information for parts used in a tool, comprising:
providing a tracking number for a part;
providing warranty duration information associated with said tracking number;
providing a data input for periodically updating an actual use duration of said part; and
displaying said tracking number, said warranty duration information and said actual use on a single page in response to a designated query about said part.

13. A method for electronically tracking contamination and decontamination of a part used in a tool for processing semiconductors, comprising:
providing a tracking number for said part;
providing a chronological list of tools in which said part has been installed; and
providing in said chronological list a description of decontamination procedures performed on said part.

14. A method for electronically tracking the history of part used in a tool, comprising:
providing a tracking number for a part;
displaying a part history on a page associated with said tracking number, said part history including, as applicable,
(a) each tool said part has been installed in, with dates of installation and removal, and
(b) each maintenance procedure performed on said part, with a date of maintenance.

15. A method for electronically tracking parts used in tools, comprising:
determining multiple part numbers corresponding to the same part; and
linking said multiple part numbers to pull up inventory information on all of said multiple part numbers in response to a query on any of said part numbers.

16. An online manual and part tracking system comprising:
descriptions of parts, said descriptions including URLs for certain of said parts;
a part tracking system including information on stocking and usage of parts, said URLs accessing information in said part tracking system for said parts, said part tracking systems including an online manual URL associated with said parts for accessing said online manual from said part tracking system.

17. The system of claim 16 wherein said URLs in said descriptions of parts comprises a base URL and a detailed URL, said base URL being imbedded in a page and pointing to said part tracking system, and said detailed URL being associated with a particular part on said page, and pointing to a description of said particular part in said part tracking system.

18. A method for electronically tracking parts inventory comprising:
providing a single description of each part type in a central repository;
providing a first list of parts in a first store, each of said parts being linked to a description in said central repository;
providing a second list of parts in a second store, each of said parts being linked to a description in said central repository, at least a portion of said parts in said second store being the same as parts in said first store;
assigning an ID to each kit of a plurality of kits, each kit having at least one part, at least one of said parts being reusable:
assigning a part number to each type of the parts in each kit;
assigning a tracking number to reusable parts;
providing a tracking number for said part;
displaying a part history on a page associated with said tracking number, said part history including, as applicable,
(a) each tool said part has been installed in, with dates of installation and removal, and
(b) each maintenance procedure performed on said part, with a date of maintenance.
